(19) United States
(12) Patent Application Publication
(10) Pub. No.: US 2024/0427167 A1
(43) Pub. Date: Dec. 26, 2024

(54) DISPLAY DEVICE AND DRIVING METHOD THEREOF

(71) Applicants: Hefei BOE Optoelectronics Technology Co., Ltd., Hefei, Anhui (CN); BOE Technology Group Co., Ltd., Beijing (CN)

(72) Inventors: Ru Zhou, Beijing (CN); Hailin Xue, Beijing (CN); Sheng Wang, Beijing (CN); Hui Wang, Beijing (CN); Xiaoqing Peng, Beijing (CN); Yuansheng Zang, Beijing (CN); Zhengwei Zhu, Beijing (CN); Xiang Wang, Beijing (CN); Yijun Wang, Beijing (CN); Jie Yang, Beijing (CN); Xufei Xu, Beijing (CN); Yingxi Tai, Beijing (CN); Baoman Li, Beijing (CN)

(73) Assignees: Hefei BOE Optoelectronics Technology Co., Ltd., Hefei, Anhui (CN); BOE Technology Group Co., Ltd., Beijing (CN)

(21) Appl. No.: 18/686,961

(22) PCT Filed: Dec. 26, 2022
(86) PCT No.: PCT/CN2022/142086

§ 371 Date: Feb. 27, 2024

(51) Int. Cl. G02B 30/31; G02B 27/00; G02F 1/29

(52) U.S. Cl. CPC G02B 30/31; G02F 1/29; G02B 27/0093

(57) ABSTRACT

A display device and a driving method thereof are provided. The display device includes: a display panel; and at least two grating panels; the grating panel includes a dielectric layer and driving structures disposed on at least one side of the dielectric layer; the grating panel includes grating units, the grating unit includes at least two driving structures; the driving structure is configured to receive a driving signal and form an electric field under the action of the driving signal; the electric field is used for driving a corresponding position of the dielectric layer to transmit light or shield light so that the grating unit forms a light-transmitting unit and a light-shielding unit; the grating panels include a first grating panel and a second grating panel stacked on a same side or two opposite sides of the display panel; the grating units are arranged along a first direction.

### TECHNICAL FIELD

The present disclosure relates to the field of display technology, and in particular to a display device and a driving method thereof.

### BACKGROUND

With the development of science and technology, three dimensional (3D) display technology has become a hot research field. Most of the existing 3D display devices require a user to wear 3D glasses for viewing, which is troublesome and has a poor user experience. Therefore, attention has been paid on an auto-stereoscopy display device that can achieve a 3D display effect without wearing 3D glasses.

### SUMMARY

The present disclosure provides a display device, including:
a display panel; and
at least two grating panels, each of the grating panels includes a dielectric layer and a plurality of driving structures disposed on at least one side of the dielectric layer; and
each of the grating panels includes a plurality of grating units, and each of the grating units includes at least two of the driving structures; the driving structure is configured to receive a driving signal and form an electric field under action of the driving signal; the electric field is used for driving a corresponding position of the dielectric layer to transmit light or shield light, so as to enable the grating unit to form a light-transmitting unit and a light-shielding unit;
the at least two grating panels include a first grating panel and a second grating panel, wherein the first grating panel and the second grating panel are stacked on a same side or two opposite sides of the display panel, and the grating units in the first grating panel and the grating units in the second grating panel are arranged along a first direction.

In some embodiments, each of the driving structures includes a plurality of driving electrodes arranged at intervals along the first direction;
an arrangement period of the grating units in the first grating panel is different from an arrangement period of the grating units in the second grating panel, and a width of the driving electrode in the first grating panel along the first direction is different from a width of the driving electrode in the second grating panel along the first direction.

In some embodiments, the first grating panel and the second grating panel are both provided close to a display side of the display panel, and the second grating panel is located between the first grating panel and the display panel; or
the first grating panel and the second grating panel are both provided facing away from the display side of the display panel, and the first grating panel is located between the second grating panel and the display panel; or
the first grating panel is provided close to the display side of the display panel, and the second grating panel is provided facing away from the display side of the display panel;
the arrangement period of the grating units in the first grating panel is less than the arrangement period of the grating units in the second grating panel, and the width of the driving electrode in the first grating panel along the first direction is less than the width of the driving electrode in the second grating panel along the first direction.

In some embodiments, the first grating panel is provided close to a display side of the display panel, and the second grating panel is provided facing away from the display side of the display panel; a distance between the first grating panel and the display panel is less than a distance between the second grating panel and the display panel.

In some embodiments, the driving structure includes a plurality of driving electrodes arranged at intervals along the first direction;
each of the grating panels further includes a wiring layer located on a side of the driving electrode facing away from the dielectric layer, the wiring layer includes a plurality of driving lines, at least part of the driving lines being connected to the driving electrode for transmitting the driving signal to the driving electrode;
each of the grating panels includes a grating area, and the plurality of driving lines are arranged along a second direction within the grating area; an orthographic projection of the driving line on the display panel intersects with an orthographic projection of the plurality of driving electrodes on the display panel;
in the second direction, an orthographic projection of the driving line in the first grating panel on the display panel at least partially overlaps with an orthographic projection of the driving line in the second grating panel on the display panel.

In some embodiments, the display panel includes:
a base substrate;
a plurality of display signal lines disposed on a side of the base substrate and arranged at intervals along the second direction; and
a plurality of first light-shielding strips disposed on a side of the plurality of display signal lines close to or facing away from the base substrate and arranged at intervals along the second direction,
in the second direction, an orthographic projection of the plurality of driving lines on the base substrate at least partially overlaps with an orthographic projection of the plurality of display signal lines on the base substrate, and an orthographic projection of the plurality of first light-shielding strips on the base substrate covers the orthographic projection of the plurality of driving lines on the base substrate.

In some embodiments, the grating area includes a common signal region; a driving line located in the common signal region has a plurality of first switching patterns, and the plurality of first switching patterns include first via switching patterns and first virtual switching patterns; the first via switching pattern is connected to the driving electrode, and the first virtual switching pattern is insulated from the driving electrode;
the plurality of first switching patterns are evenly arranged at equal intervals in the first direction within the common signal region.

In some embodiments, a size of an orthographic projection of the first via switching pattern on the display panel is greater than or equal to a size of an orthographic projection of the first virtual switching pattern on the display panel.

In some embodiments, the grating area further includes a functional region; a driving line located in the functional region has a plurality of second switching patterns, and the plurality of second switching patterns includes second virtual switching patterns; the second virtual switching pattern is insulated from the driving electrode;
the plurality of second switching patterns are obtained by translating the plurality of first switching patterns along the first direction and/or the second direction.

In some embodiments, the plurality of second switching patterns are evenly arranged at equal intervals in the first direction within the functional region; and
an arrangement period of the plurality of first switching patterns in the first direction is different from an arrangement period of the plurality of second switching patterns in the first direction.

In some embodiments, the grating area includes a plurality of common signal regions, and two of the common signal regions adjacent in the first direction are a first common signal region and a second common signal region; a plurality of first switching patterns in the first common signal region close to the second common signal region are located on substantially a same straight line as a plurality of first switching patterns in the second common signal region close to the first common signal region.

In some embodiments, in the first direction, an orthographic projection of a grating area of the first grating panel on the display panel covers an effective display area of the display panel, and an orthographic projection of a grating area of the second grating panel on the display panel covers the effective display area;
in response to a distance between the first grating panel and the display panel being greater than a distance between the second grating panel and the display panel, a distance in the first direction between a boundary of the orthographic projection of the grating area of the first grating panel on the display panel and a boundary of the effective display area is greater than a distance in the first direction between a boundary of the orthographic projection of the grating area of the second grating panel on the display panel and the boundary of the effective display area;
in response to the distance between the second grating panel and the display panel being greater than the distance between the first grating panel and the display panel, the distance in the first direction between the boundary of the orthographic projection of the grating area of the second grating panel on the display panel and the boundary of the effective display area is greater than the distance in the first direction between the boundary of the orthographic projection of the grating area of the first grating panel on the display panel and the boundary of the effective display area.

In some embodiments, each of the driving structures includes a plurality of driving electrodes arranged at intervals along the first direction;
in a state where the dielectric layers in the grating panels are all in a light-shielding state, a ratio of transmittance of the at least two grating panels to a thickness of the driving electrode is greater than or equal to 1.3*10⁻⁸ Å⁻¹, and less than or equal to 2.86*10⁻⁸ Å⁻¹.

In some embodiments, the display device is a three dimensional (3D) display device, and a crosstalk value between different viewpoint pictures of the 3D display device is less than or equal to 0.2%.

In some embodiments, the driving signal includes a first voltage signal and a second voltage signal;
each of the driving structures includes a first electrode and a second electrode, the first electrode is configured to receive the first voltage signal, and the second electrode is configured to receive the second voltage signal; the first electrode and the second electrode are disposed on two opposite sides of the dielectric layer;
a plurality of first electrodes are communicated with each other as an integral structure, and a plurality of second electrodes are arranged along the first direction and are spaced apart from each other;
a plurality of second electrodes includes a first sub-electrode and a second sub-electrode, wherein the first sub-electrode and the second sub-electrode are disposed on different filmi layers, and in the first direction, an orthographic projection of the first sub-electrode on the display panel and an orthographic projection of the second sub-electrode on the display panel are alternately arranged.

In some embodiments, the driving signal includes a third voltage signal and a fourth voltage signal;
each of the driving structures includes a third electrode and a fourth electrode; the third electrode is configured to receive the third voltage signal, and the fourth electrode is configured to receive the fourth voltage signal; the third electrode and the fourth electrode are disposed on a same side of the dielectric layer;
the third electrode and the fourth electrode are disposed on different film layers, a plurality of third electrodes are communicated with each other as an integral structure, and a plurality of fourth electrodes are arranged along the first direction and are spaced apart from each other in a same film layer; or
a plurality of third electrodes and a plurality of fourth electrodes are disposed on a same layer, wherein the plurality of third electrodes are arranged along the first direction and are spaced apart from each other, the plurality of fourth electrodes are arranged along the first direction and are spaced apart from each other, and the third electrodes and the fourth electrodes are provided alternately in the first direction.

In some embodiments, a ratio of an area of the light-transmitting unit to an area of the grating unit is greater than or equal to 0.4, and less than or equal to 0.6.

In some embodiments, the display device is a 3D display device, and the 3D display device further includes:
an eyeball tracking module, configured to acquire a viewing distance; and
a driving module, connected to the eyeball tracking module and the driving structures and configured to adjust a position and a size of the light-transmitting unit in the grating unit according to the viewing distance.

The present disclosure provides a driving method of a display device, applied to any display device described above, the display device includes a display panel and at least two grating panels; each of the grating panels includes a plurality of grating units, and a driving method of the grating unit includes:
in a two dimensional (2D) display stage, providing a first driving signal to driving structures located in a same grating unit to drive a corresponding position of the dielectric layer to transmit light so that the entire grating unit forms the light-transmitting unit; and
in a three dimensional (3D) display stage, providing the first driving signal to a part of the driving structures located in the same grating unit to drive a corresponding position of the dielectric layer to transmit light, and providing a second driving signal to another part of the driving structures located in the same grating unit to drive a corresponding position of the dielectric layer to shield light so that the grating unit form the light-transmitting unit and the light-shielding unit.

In some embodiments, the driving structure includes a common electrode and a driving electrode; the providing a first driving signal to driving structures located in a same grating unit and the providing the first driving signal to a part of the driving structures located in the same grating unit include:
in a normally black mode, providing different voltage signals to the common electrode and the driving electrode to drive a corresponding position of the dielectric layer to transmit light; and
in a normally white mode, providing a same voltage signal to the common electrode and the driving electrode to drive the corresponding position of the dielectric layer to transmit light;
the providing a second driving signal to another part of the driving structures located in the same grating unit includes:
in the normally black mode, providing the same voltage signal to the common electrode and the driving electrode to drive the corresponding position of the dielectric layer to shield light; and
in the normally white mode, providing different voltage signals to the common electrode and the driving electrode to drive the corresponding position of the dielectric layer to shield light.

The above explanation is merely an overview of the technical solutions of the present disclosure. In order to know about the technical means of the present disclosure more clearly so that the solutions may be implemented according to the contents of the specification, and in order to make the above and other objects, features and advantages of the present disclosure more apparent and understandable, specific implementations of the present disclosure are set forth below.

### BRIEF DESCRIPTION OF THE DRAWINGS

In order to illustrate technical solutions of the embodiments of the present disclosure or the related art more clearly, the accompanying drawings used in the illustration of the embodiments or the related art will be briefly introduced. Apparently, the accompanying drawings in the following explanation illustrate merely some embodiments of the present disclosure, and those skilled in the art may obtain other accompanying drawings based on these accompanying drawings without paying any creative effort. It should be noted that the proportions in the figures are only indicative and do not represent actual proportions.

FIG. 1 is a schematic diagram schematically illustrating a cross-sectional structure of a display device in the related art;

FIG. 2 is a schematic diagram schematically illustrating an optical path of a display device in the related art;

FIG. 3 is a schematic diagram schematically illustrating left and right eye views of a display device in the related art;

FIG. 4 is a diagram schematically illustrating a principle of generating ghosting in a display device in the related art;

FIG. 5 is a diagram schematically illustrating L0 brightness of a grating panel from a horizontal viewing angle of −45° to 45°;

FIG. 6 is a diagram schematically illustrating a full viewing angle contrast of a grating panel;

FIG. 7 is a diagram schematically illustrating L0 brightness of another grating panel from a horizontal viewing angle of −45° to 45°;

FIG. 8 is a diagram schematically illustrating a full viewing angle contrast of another grating panel;

FIG. 9 is a schematic diagram schematically illustrating a cross-sectional structure of a first display device provided by the present disclosure;

FIG. 10 is a schematic diagram schematically illustrating a cross-sectional structure of a second display device provided by the present disclosure;

FIG. 11 is a schematic diagram schematically illustrating a cross-sectional structure of a third display device provided by the present disclosure;

FIG. 12 is a schematic diagram schematically illustrating an optical path of the first display device provided by the present disclosure;

FIG. 13 is a schematic diagram schematically illustrating an optical path of the second display device provided by the present disclosure;

FIG. 14 is a schematic diagram schematically illustrating an optical path of the third display device provided by the present disclosure;

FIG. 15 is a diagram schematically illustrating display effects of several display devices;

FIG. 16 is a schematic diagram schematically illustrating a configuration of a first grating panel;

FIG. 17 is a schematic diagram schematically illustrating a configuration of a second grating panel;

FIG. 18 is a schematic diagram schematically illustrating a configuration of a third grating panel;

FIG. 19 is a schematic diagram schematically illustrating a configuration of a fourth grating panel;

FIG. 20 is a schematic diagram schematically illustrating a planar construction of a second electrode;

FIG. 21 is a schematic diagram schematically illustrating a planar construction of a third electrode and a fourth electrode;

FIG. 22 is a schematic diagram schematically illustrating another planar construction of the third electrode and the fourth electrode;

FIG. 23 is a schematic diagram schematically illustrating cross-sectional structures of several grating panels;

FIG. 24 is a schematic diagram schematically illustrating a cross-sectional structure of a first grating panel and a second grating panel;

FIG. 25 is a schematic diagram schematically illustrating a planar construction of a driving electrode and a driving line of a grating area;

FIG. 26 is a schematic diagram schematically illustrating a planar construction of a driving line of a grating area;

FIG. 27 is a partially enlarged schematic structural diagram of FIG. 26;

FIG. 28 is a schematic diagram schematically illustrating an equivalent schematic structural diagram of several display devices;

FIG. 29 is a schematic diagram schematically illustrating a planar construction of a display device;

FIG. 30 is a schematic alignment structural diagram of several display devices;

FIG. 31 is a schematic diagram schematically illustrating a planar construction of a grating panel; and

FIG. 32 schematically shows a white light brightness distribution curve of each view under different viewing angles.

### DETAILED DESCRIPTION

A clear and thorough illustrating for technical solutions in the embodiments of the present disclosure will be given below in conjunction with the accompanying drawings in the embodiments of the present disclosure. Apparently, the described embodiments are merely a part of embodiments of the present disclosure, not all the embodiments. All other embodiments obtained, based on the embodiments in the present disclosure, by those skilled in the art without paying creative effort fall within the protection scope of the present disclosure.

In order to enjoy the 3D display effect more comfortably and get rid of the constraint of special glasses, the auto-stereoscopy has been developed greatly. The related technologies mainly include fixed gratings, electronic gratings, cylindrical lenses, directional backlights, active backlights, etc.

The auto-stereoscopy technology is divided into two main categories: reproducing binocular parallax and an original light field. A principle of reproducing binocular parallax is that the left and right eyes of a person each receive two views with parallax, and the two views are synthesized in the brain to produce a 3D effect. Therefore, a 3D image can be generated by performing some processing on the screen to map images with parallax to the left and right eyes of a person.

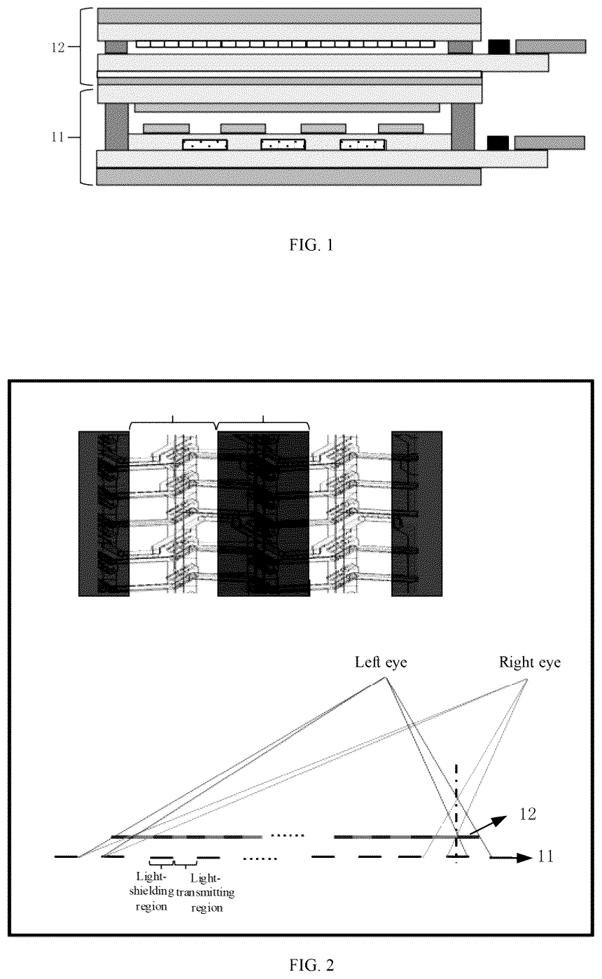

The electronic grating is an auto-stereoscopy technical solution for reproducing binocular parallax. Referring to FIG. 1, a schematic diagram of a cross-sectional structure of a display device in the related art is shown. As shown in FIG. 1, the display device includes a grating panel 11 and a display panel 12 that are stacked. The grating panel 11 is an electronic grating, and by controlling liquid crystal deflection in the grating panel 11, light-transmitting or light-shielding of different regions may be realized, forming a light-transmitting region and a light-shielding region so that the left and right eyes receive different views, as shown in FIG. 2.

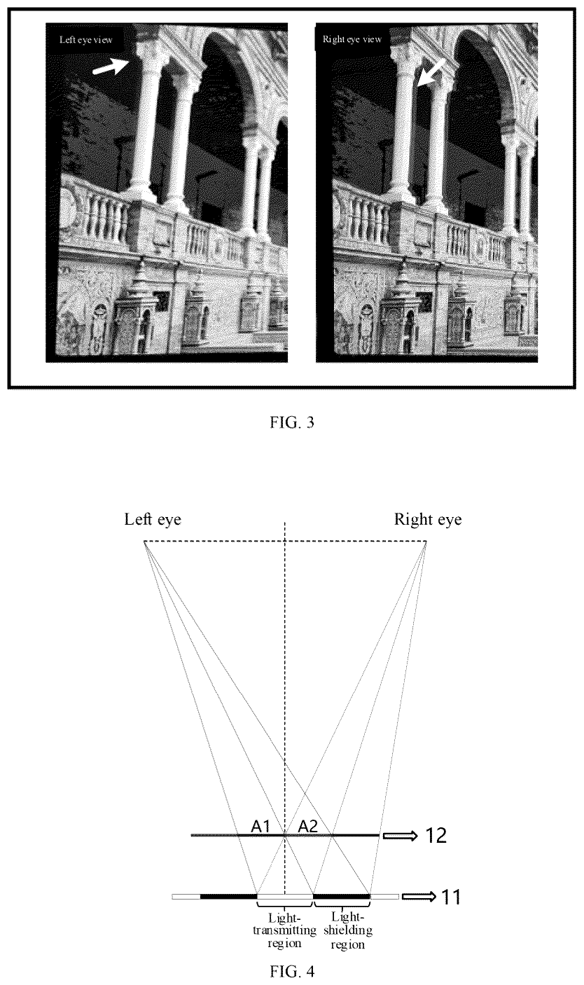

However, the display device as shown in FIG. 1 has a serious ghosting problem. As shown in FIG. 3, at a best viewpoint position, a left eye view and a right eye view show ghosting (as indicated by the arrow in FIG. 3), and the human eye moves left and right, aggravating the ghosting problem.

The inventor has analyzed the defect, and as shown in FIG. 4, when a 3D picture is normally viewed, by controlling the grating panel 11, the left eye can only see a first view A1, and the right eye can only see a second view A2. Since there is a parallax between the first view A1 and the second view A2, the 3D effect may be generated. However, due to light leakage in the light-shielding region of the grating panel 11, the right eye can see the first view A1 with a certain brightness in addition to the second view A2, and the left eye can see the second view A2 with a certain brightness in addition to the first view A1, resulting in ghosting in both the left and right eye views.

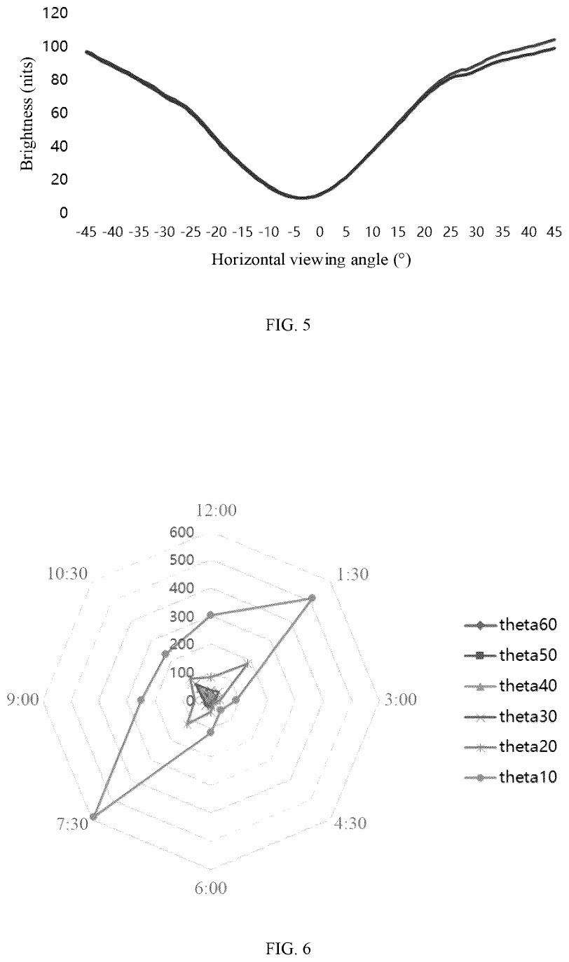

To verify the above-mentioned analysis results, the inventor has performed an optical test on the grating panel 11 shown in FIG. 1. Referring to FIG. 5, L0 brightness data of the grating panel 11 from a horizontal viewing angle of −45° to 45° is shown. L0 brightness is the brightness of light transmitted through the grating panel 11 when the whole grating panel 11 is in a light-shielding state. As can be seen from FIG. 5, as the horizontal viewing angle increases, the L0 brightness increases sharply, and a minimum value of the L0 brightness is also as high as 10 nits. The results of this test indicate that the light-shielding region shown in FIG. 4 is not sufficiently dark and light is transmitted, resulting in the ghosting problem shown in FIG. 3. The inventor has also tested a full viewing angle contrast of the grating panel 11 shown in FIG. 1, and the results are shown in FIG. 6. It can be found that the contrast in an oblique 45° viewing angle direction is high.

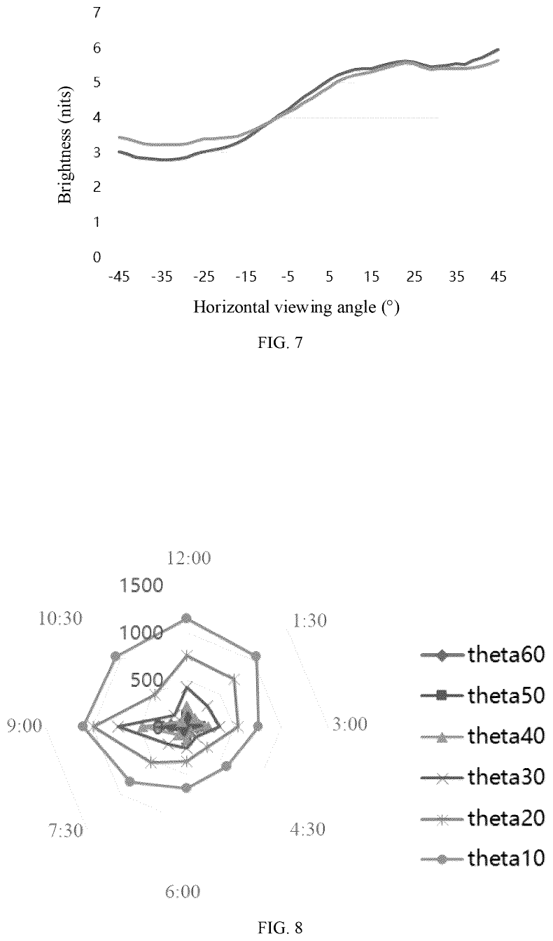

The inventor has improved the grating panel 11 shown in FIG. 1. Referring to FIG. 7, L0 brightness data of an improved grating panel 11 from a horizontal viewing angle of −45° to 45° is shown. Referring to FIG. 8, a full viewing angle contrast of the improved grating panel 1 1 is shown. It can be seen from FIG. 7 and FIG. 8 that the L0 brightness of the improved grating panel 11 is greatly reduced and the full viewing angle contrast is significantly improved. The display effect of the display device is tested using the improved grating panel 11, and it is found that a side viewing angle ghosting phenomenon is significantly improved, which indicates that the ghosting phenomenon is related to the L0 brightness of the grating panel 11. However, the ghosting phenomenon still exists regardless of the front viewing angle or the side viewing angle of the improved grating panel 11.

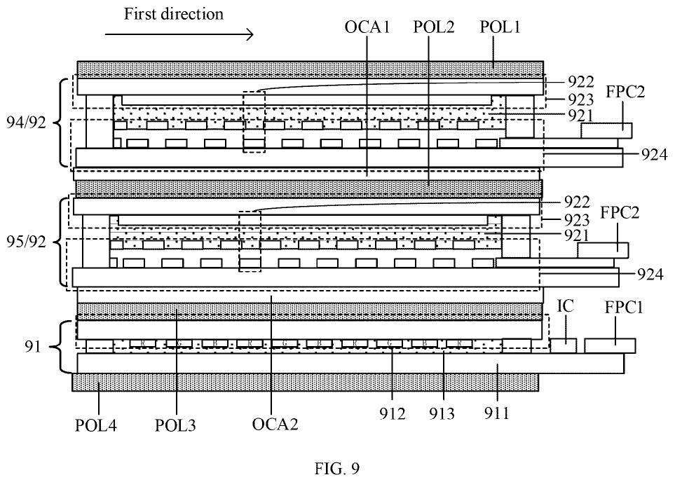

In order to solve the ghosting problem, the present disclosure provides a display device. As shown in any one of FIGS. 9 to 11, the display device includes a display panel 91 and at least two grating panels 92.

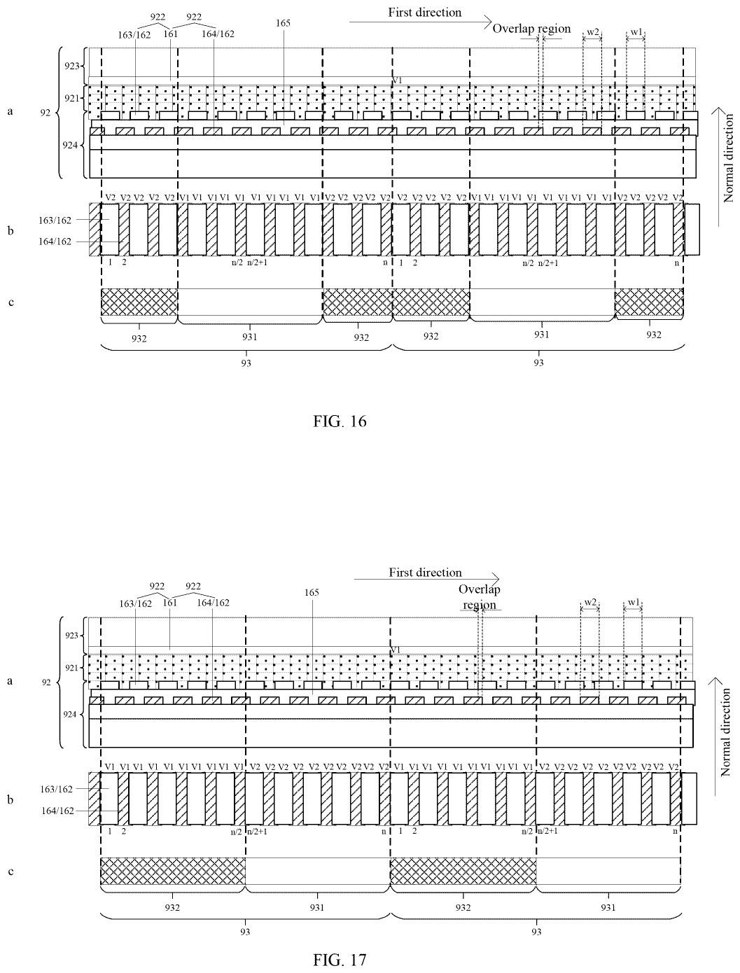

As shown in any one of FIGS. 9 to 11 and FIGS. 16 to 19, the grating panel 92 includes a dielectric layer 921 and a plurality of driving structures 922 provided on at least one side of the dielectric layer 921. The grating panel 92 includes a plurality of grating units 93 (as shown in any one of FIGS. 16 to 19), and the grating unit 93 includes at least two driving structures 922. The driving structure 922 is configured to receive a driving signal and form an electric field under the action of the driving signal. The electric field is used for driving a corresponding position of the dielectric layer 921 to transmit light or shield light so that the grating unit 93 forms a light-transmitting unit 931 and a light-shielding unit 932.

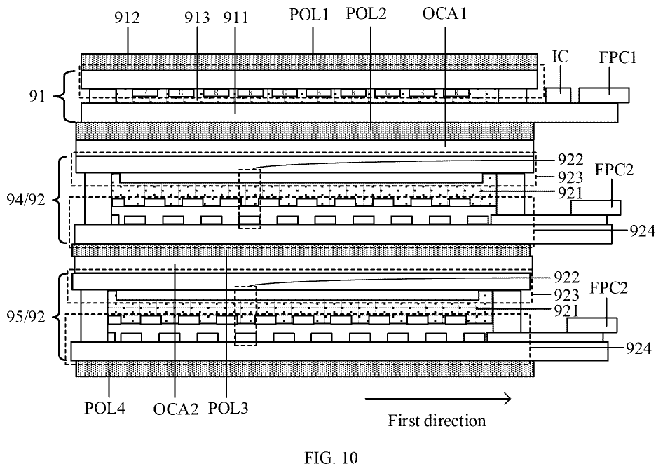

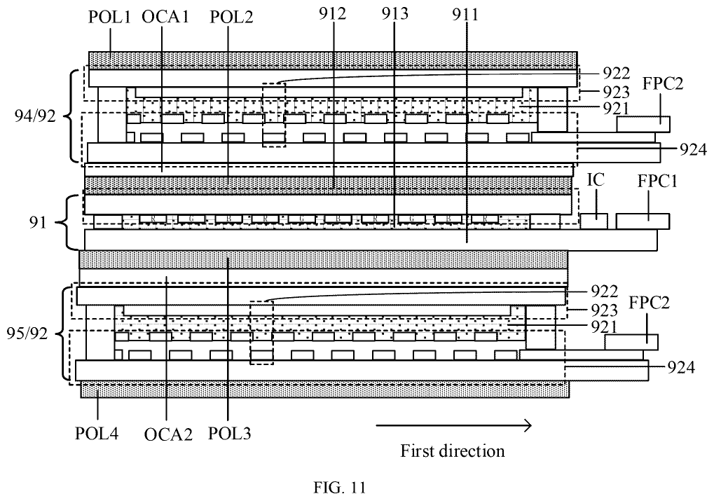

As shown in any one of FIGS. 9 to 11, the at least two grating panels 92 include a first grating panel 94 and a second grating panel 95. The first grating panel 94 and the second grating panel 95 are stacked on a same side (as shown in FIGS. 9 and 10) or two opposite sides (as shown in FIG. 11) of the display panel 91, and a plurality of grating units 93 in the first grating panel 94 and a plurality of grating units 93 in the second grating panel 95 are arranged along a first direction.

The display device provided in the present disclosure is capable of freely switching between 2D display and 3D display. In a specific implementation, in a 2D display stage, a first driving signal may be provided to all driving structures 922 located in a same grating unit 93 to drive a corresponding position of the dielectric layer 921 to transmit light so that the entire grating unit 93 forms the light-transmitting unit 931. In a 3D display stage, the first driving signal may be provided to a part of the driving structures 922 located in the same grating unit 93 to drive a corresponding position of the dielectric layer 921 to transmit light, thereby forming the light-transmitting unit 931. Meanwhile, a second driving signal may be provided to another part of the driving structures 922 located in the same grating unit 93 to drive a corresponding position of the dielectric layer 921 to shield light, thereby forming the light-shielding unit 932.

The light-transmitting unit 931 is configured to transmit light (equivalent to an opening of the grating unit 93), and the light-shielding unit 932 is configured to shield light. The plurality of grating units 93 cooperate with the grating panel 92 to form an electronic grating having a plurality of openings. An opening ratio of the grating unit 93 is an area of the light-transmitting unit 931/(the area of the light-transmitting unit 931+an area of the light-shielding unit 932).

In a specific implementation, in the 3D display stage, by adjusting the number and position of the driving structures 922 receiving the first driving signal in one grating unit 93, the size and position of the light-transmitting unit 931 in the grating unit 93 may be adjusted so that an opening ratio and/or an opening position (i.e., the position of the light-transmitting unit 931) of the grating unit 93 may be adjusted.

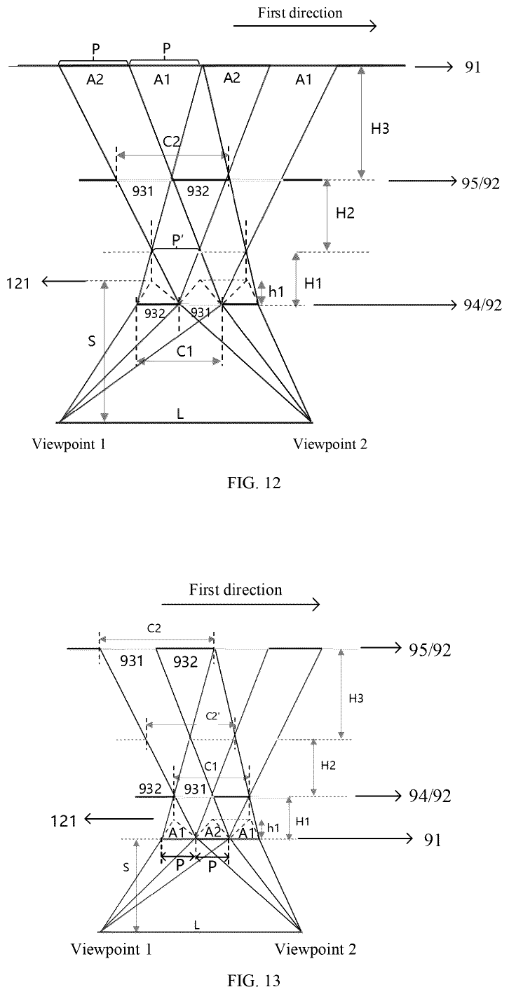

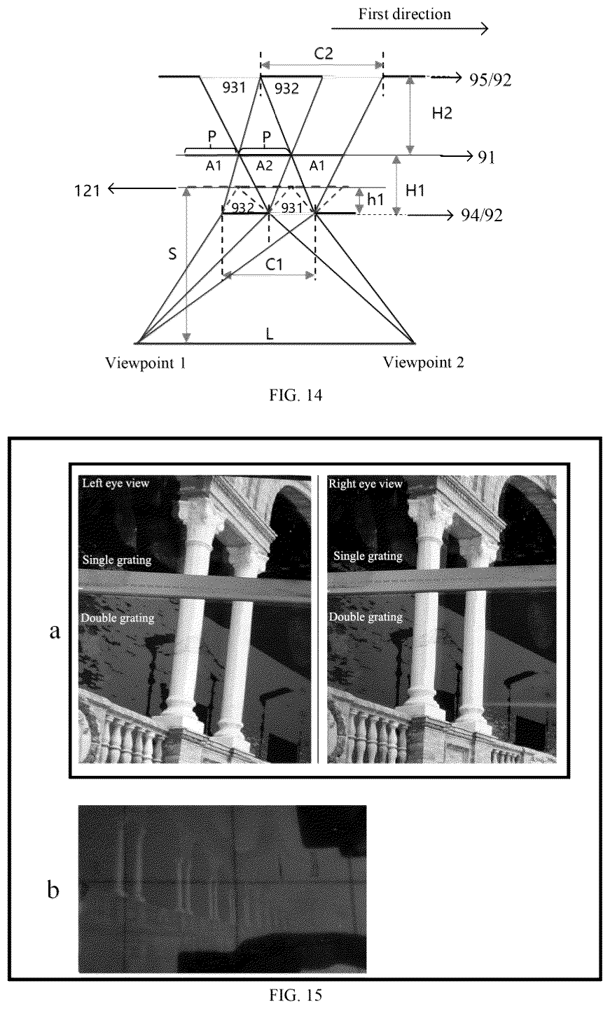

Referring to FIG. 12, a schematic diagram of an optical path of the display device shown in FIG. 9 is shown, referring to FIG. 13, a schematic diagram of an optical path of the display device shown in FIG. 10 is shown, and referring to FIG. 14, a schematic diagram of an optical path of the display device shown in FIG. 11 is shown.

As shown in FIGS. 12 to 14, a viewpoint 1 may be a position of the left eye, and a viewpoint 2 may be a position of the right eye. Each grating unit 93 in two grating panels 92 is controlled to form the light-transmitting unit 931 and the light-shielding unit 932 so that when the first view A1 in the display panel 91 is viewed, the viewpoint 1 corresponds to the light-transmitting units 931 of the two grating panels 92, and the viewpoint 2 corresponds to the light-shielding units 932 of the two grating panels 92, namely, the first view A1 can be seen by the viewpoint 1 and cannot be seen by the viewpoint 2 at a same observation moment. Similarly, each grating unit 93 in two grating panels 92 may also be controlled to form the light-transmitting unit 931 and the light-shielding unit 932 so that the second view A2 can be seen by the viewpoint 2 and cannot be seen by the viewpoint 1 at a same observation moment. Since the first view A1 seen by the viewpoint 1 has a parallax with the second view A2 seen by the viewpoint 2, stereoscopic vision may be formed to realize 3D display.

As shown in FIGS. 12 to 14, when the first view A1 of the display panel 91 is viewed by the viewpoint 2, the first view A1 light needs to pass through two grating panels 92, and the light-shielding units 932 in the two grating panels 92 shield and filter the first view A1 light twice to ensure that the first view A1 can be seen by the viewpoint I and cannot be seen by the viewpoint 2 completely, and similarly, the second view A2 can be seen by the viewpoint 2 and cannot be seen by the viewpoint I completely, thereby eliminating the ghosting. Finally, a user can see a 3D image without crosstalk.

The inventor has verified the effects of the display device shown in FIGS. 9 to 11. As shown in FIG. 15a, the left eye view and the right eye view marked with a single grating are display effect diagrams of the display device shown in FIG. 1, and the left eye view and the right eye view marked with a double grating are display effect diagrams of the display device shown in FIGS. 9 to 11. By comparison, it can be seen that the ghosting problem is completely invisible in both the left eye view and the right eye view for a display device with a double-grating panel.

The display device provided by the present disclosure may achieve an auto-stereoscopy effect by providing at least two grating panels 92 on one or two sides of the display panel 91, may effectively solve the ghosting problem, significantly improve the 3D display effect, and improve the user's acceptance of the auto-stereoscopy technology.

The inventor has also tested the display device in the related art (as shown in FIG. 1). The L0 brightness of the grating panel 11 is tested to be less than or equal to 0.15 nits by reducing the backlight brightness to the point that the ghosting phenomenon is completely invisible to the human eye, as shown in FIG. 15b.

The inventor has also tested the L0 brightness of the two grating panels 92 in the display device as shown in FIG. 10 (namely, the brightness of the backlight transmitting the two grating panels 92 when all of the grating units 93 in the two grating panels 92 are light-shielding units 932), the backlight brightness used in the test is 8910 nits, and the L0 brightness of the two grating panels 92 is tested to be 0.016 nits, which is much less than 0.15 nits, meeting the L0 brightness requirement for eliminating the ghosting.

According to the L0 brightness and the backlight brightness of the above-mentioned two grating panels 92, the transmittance of the two grating panels 92 may be calculated as 0.016 nits/8910 nits≈0.00018%.

In some implementations, the transmittance of at least two grating panels 92 in the display device is less than or equal to 0.002%, 0.0017%, 0.0015%, 0.001%, 0.0005%, or 0.0002%, such as 0.00018% described above, with all of the dielectric layers 921 in the grating panels 92 in a light-shielding state, i.e., with all of the grating panels 92 being the light-shielding units 932.

In order to increase the brightness of a display picture of the display device, in some implementations, a ratio of the area of the light-transmitting unit 931 to an area of the grating unit 93 is greater than or equal to 0.4 and less than or equal to 0.6. Namely, the opening ratio of the grating unit 93 is greater than or equal to 40% and less than or equal to 60%.

In order to further improve the brightness of the display device, the ratio of the area of the light-transmitting unit 931 to the area of the grating unit 93 may be set to 0.5, that is, the area of the light-transmitting unit 931 is the same as the area of the light-shielding unit 932, and the opening ratio of the grating unit 93 is 50%.

In a specific implementation, as shown in any one of FIGS. 9-11 and FIGS. 16-19, the grating panel 92 may include a first substrate 923 and a second substrate 924 oppositely provided, and the dielectric layer 921 is provided between the first substrate 923 and the second substrate 924. The driving structure 922 is provided on a side of the first substrate 923 and/or the second substrate 924 close to the dielectric layer 921.

In some implementations, as shown in any one of FIGS. 9 to 11, the display panel 91 is a liquid crystal display panel and includes an array substrate 911 and a cell alignment substrate 912 oppositely provided, and a liquid crystal layer 913 located between the array substrate 911 and the cell alignment substrate 912. The cell alignment substrate 912 is provided close to a display side of the display panel 91.

In some implementations, as shown in any one of FIGS. 12 to 14, an arrangement period C1 of the grating units 93 in the first grating panel 94 is different from an arrangement period C2 of the grating units 93 in the second grating panel 95 in the first direction.

The arrangement period C1 of the grating units 93 in the first grating panel 94 and the arrangement period C2 of the grating units 93 in the second grating panel 95 will be described below in conjunction with a relative positional relationship between the two grating panels 92 and the display panel 91.

In a first example, as shown in FIG. 9, the first grating panel 94 and the second grating panel 95 are located on the same side of the display panel 91 and are both provided close to the display side of the display panel 91, and the second grating panel 95 is located between the first grating panel 94 and the display panel 91.

As shown in FIGS. 9 and 12, the display panel 91, the second grating panel 95, and the first grating panel 94 are sequentially stacked, with the display panel 91 away from the viewpoint and the first grating panel 94 close to the viewpoint.

Referring to FIG. 12, the position of a user's left eye is marked as the viewpoint 1, the position of a user's right eye is marked as the viewpoint 2, a distance between two eyes is an interpupillary distance L, an designed optimal viewing distance is marked as S, a width of one pixel unit in the display panel 91 along the first direction is P, a display picture corresponding to the left eye is marked as the first view A1, a display picture corresponding to the right eye is marked as the second view A2, a width of one grating unit 93 in the first grating panel 94 along the first direction is marked as the arrangement period C1 of the grating unit, and a width of one grating unit 93 in the second grating panel 95 along the first direction is marked as the arrangement period C2 of the grating unit. A distance between the first grating panel 94 and the second grating panel 95 is marked as an actual placement height H1+H2, and a distance between the second grating panel 95 and the display panel 91 is marked as an actual placement height H3.

It should be noted that, as shown in FIG. 12, the optimal viewing distance S represents a distance between the human eye (the viewpoint 1 and the viewpoint 2) and an imaging plane 121 of the display panel 91. The imaging plane 121 is a plane in which an image of a display picture on the display panel 91 is refracted. In the first direction, the grating unit 93 is divided into the light-transmitting unit 931 and the light-shielding unit 932. Therefore, a width of the grating unit 93 is equal to a sum of a width of the light-transmitting unit 931 and a width of the light-shielding unit 932. The display panel 91 may include a plurality of pixel units arranged in an array, and the pixel units may include a plurality of sub-pixels, such as a red sub-pixel, a green sub-pixel, and a blue sub-pixel.

The distance between the first grating panel 94 and the second grating panel 95 (namely, the actual placement height H1+H2) is a distance between the dielectric layer 921 of the first grating panel 94 and the dielectric layer 921 of the second grating panel 95. As shown in FIG. 9, the second substrate 924 of the first grating panel 94, an optical adhesive layer OCA1, a polarizer POL2, and the first substrate 923 of the second grating panel 95 are included between the dielectric layer 921 of the first grating panel 94 and the dielectric layer 921 of the second grating panel 95.

When the display panel 91 is the liquid crystal display panel, the distance between the second grating panel 95 and the display panel 91 is a distance between the dielectric layer 921 of the second grating panel 95 and the liquid crystal layer 913 of the display panel 91. As shown in FIG. 9, the second substrate 924 of the second grating panel 95, an optical adhesive layer OCA2, a polarizer POL3, and the cell alignment substrate 912 are included between the dielectric layer 921 of the second grating panel 95 and the liquid crystal layer 913 of the display panel 91.

As shown in FIG. 12, according to a geometric relationship of triangles, it may be obtained:

$$\begin{matrix}\frac{C 1}{2 L} = \frac{h 1}{S} \\ \frac{C 1}{2 {P}^{′}} = \frac{S - h 1}{S} \\ H 1 = h 1 * n \\ \frac{{P}^{′}}{C 1} = \frac{H 2}{H 1 + H 2} \\ \frac{{P}^{′}}{C 2} = \frac{H 1}{H 1 + H 2} \\ \frac{C 2}{4 P} = \frac{H 2}{H 2 + H S} \\ \frac{C 2}{4 {P}^{′}} = \frac{H 3}{H 2 + H 3}\end{matrix}$$

According to the above formula, it may be obtained:

$$\begin{matrix}C 1 = \frac{2 P L}{L + 3 P} \\ H 1 = \frac{S P}{L + 3 P} * n \\ C 2 = \frac{2 P L}{L + P} \\ H 2 = \frac{S P}{L + P} * n \\ H 3 = \frac{S P * ( 2 P + L )}{L * ( L + P )} * n \\ H 1 + H 2 = \frac{2 S P * ( 2 P + L )}{( L + P ) * ( L + 3 P )} * n\end{matrix}$$

h1 represents a virtual placement height between the first grating panel 94 and the imaging plane 121, and n is an equivalent refractive index of the display device. According to the above formula, the arrangement period C1 of the grating units 93 in the first grating panel 94, the arrangement period C2 of the grating units 93 in the second grating panel 95, the actual placement height H1+H2, and the actual placement height H3 may be calculated.

According to the above formula, as shown in FIG. 9, the arrangement period C1 of the grating units 93 in the first grating panel 94 is less than the arrangement period C2 of the grating units 93 in the second grating panel 95, as shown in FIG. 12.

According to the above formula, a ratio of the actual placement height H1+H2 to the actual placement height H3 satisfies the following formula:

$$\frac{H 1 + H 2}{H 3} = \frac{2 L}{L + 3 P}$$

In a second example, as shown in FIG. 10, the first grating panel 94 and the second grating panel 95 are located on the same side of the display panel 91 and are both provided away from the display side of the display panel 91, and the first grating panel 94 is located between the second grating panel 95 and the display panel 91.

As shown in FIGS. 10 and 13, the second grating panel 95, the first grating panel 94, and the display panel 91 are sequentially stacked, with the display panel 91 close to the viewpoint and the second grating panel 95 away from the viewpoint.

Referring to FIG. 13, the position of the user's left eye is marked as the viewpoint 1, the position of the user's right eye is marked as the viewpoint 2, the distance between two eyes is the interpupillary distance L, the designed optimal viewing distance is marked as S, the width of one pixel unit in the display panel 91 along the first direction is P, the display picture corresponding to the left eye is marked as the first view A1, the display picture corresponding to the right eye is marked as the second view A2, the width of one grating unit 93 in the first grating panel 94 along the first direction is marked as the arrangement period C1 of the grating unit 93, and the width of one grating unit 93 in the second grating panel 95 along the first direction is marked as the arrangement period C2 of the grating unit 93. A distance between the first grating panel 94 and the display panel 91 is marked as an actual placement height H1, and a distance between the second grating panel 95 and the first grating panel 94 is marked as an actual placement height H2+H3.

It should be noted that, as shown in FIG. 13, the optimal viewing distance S represents a distance between the human eye (the viewpoint 1 and the viewpoint 2) and the display panel 91. In the first direction, the grating unit 93 is divided into the light-transmitting unit 931 and the light-shielding unit 932. Therefore, the width of the grating unit 93 is equal to the sum of the width of the light-transmitting unit 931 and the width of the light-shielding unit 932. The display panel 91 may include the plurality of pixel units arranged in an array, and the pixel units may include the plurality of sub-pixels, such as the red sub-pixel, the green sub-pixel, and the blue sub-pixel.

When the display panel 91 is the liquid crystal display panel, the distance between the first grating panel 94 and the display panel 91 is a distance between the dielectric layer 921 of the first grating panel 94 and the liquid crystal layer 913 of the display panel 91. As shown in FIG. 10, the first substrate 923 of the first grating panel 94, the optical adhesive layer OCA1, the polarizer POL2, and the array substrate 911 are included between the dielectric layer 921 of the first grating panel 94 and the liquid crystal layer 913 of the display panel 91. The distance between the second grating panel 95 and the first grating panel 94 is the distance between the dielectric layer 921 of the first grating panel 94 and the dielectric layer 921 of the second grating panel 95. The second substrate 924 of the first grating panel 94, the optical adhesive layer OCA2, the polarizer POL3, and the first substrate 923 of the second grating panel 95 are included between the dielectric layer 921 of the first grating panel 94 and the dielectric layer 921 of the second grating panel 95.

As shown in FIG. 13, according to the geometric relationship of triangles, it may be obtained:

$$\begin{matrix}\frac{P}{L} = \frac{h 1}{S + h 1} \\ \frac{C 1}{2 P} = \frac{S + h 1}{S} \\ H 1 = h 1 * n \\ \frac{C 1}{4 P} = \frac{H 2}{H 1 + H 2} \\ \frac{C 1}{2 C {2}^{′}} = \frac{H 1}{H 1 + H 2} \\ \frac{C {2}^{′}}{2 C 2} = \frac{H 2}{H 2 + H 3} \\ \frac{C {2}^{′}}{2 C 1} = \frac{H 3}{H 2 + H 3}\end{matrix}$$

According to the above formula, it may be obtained:

$$\begin{matrix}C 1 = \frac{2 P L}{L - P} \\ H 1 = \frac{S P}{L - P} * n \\ C 2 = \frac{2 P L}{L - 3 P} \\ H 2 = \frac{S P L}{( L - P ) * ( L - 2 P )} * n \\ H 3 = \frac{S P L}{( L - 2 P ) * ( L - 3 P )} * n \\ H 2 + H 3 = \frac{2 S P L}{( L - P ) * ( L - 3 P )} * n\end{matrix}$$

h1 represents a distance between the display panel 91 and the imaging plane 121, and n is the equivalent refractive index of the display device. According to the above formula, the arrangement period C1 of the grating units 93 in the first grating panel 94, the arrangement period C2 of the grating units 93 in the second grating panel 95, the actual placement height H1, and the actual placement height H2+H3 may be calculated.

According to the above formula, in the display device shown in FIG. 10, the arrangement period C1 of the grating units 93 in the first grating panel 94 is less than the arrangement period C2 of the grating units 93 in the second grating panel 95, as shown in FIG. 13.

According to the above formula, a ratio of the actual placement height H1 to the actual placement height H2+H3 satisfies the following formula:

$$\frac{H 1}{H 2 + H 3} = \frac{L - 3 P}{2 L}$$

In a third example, as shown in FIG. 11, the first grating panel 94 is provided close to the display side of the display panel 91, and the second grating panel 95 is provided away from the display side of the display panel 91. Namely, the first grating panel 94 and the second grating panel 95 are oppositely provided on two sides of the display panel 91.

As shown in FIGS. 11 and 14, the second grating panel 95, the display panel 91, and the first grating panel 94 are sequentially stacked, with the second grating panel 95 away from the viewpoint and the first grating panel 94 close to the viewpoint.

Referring to FIG. 14, the position of the user's left eye is marked as the viewpoint 1, the position of the user's right eye is marked as the viewpoint 2, the distance between two eyes is the interpupillary distance L, the designed optimal viewing distance is marked as S, the width of one pixel unit in the display panel 91 along the first direction is P, the display picture corresponding to the left eye is marked as the first view A1, the display picture corresponding to the right eye is marked as the second view A2, the width of one grating unit 93 in the first grating panel 94 along the first direction is marked as the arrangement period C1 of the grating unit 93, and the width of one grating unit 93 in the second grating panel 95 along the first direction is marked as the arrangement period C2 of the grating unit 93. The distance between the first grating panel 94 and the display panel 91 is marked as the actual placement height H1, and a distance between the second grating panel 95 and the display panel 91 is marked as the actual placement height H2.

It should be noted that, as shown in FIG. 14, the optimal viewing distance S represents the distance between the human eye (the viewpoint 1 and the viewpoint 2) and the imaging plane 121 of the display panel 91. The imaging plane 121 is the plane in which the image of the display picture on the display panel 91 is refracted. In the first direction, the grating unit 93 is divided into the light-transmitting unit 931 and the light-shielding unit 932. Therefore, the width of the grating unit 93 is equal to the sum of the width of the light-transmitting unit 931 and the width of the light-shielding unit 932. The display panel 91 may include the plurality of pixel units arranged in an array, and the pixel units may include the plurality of sub-pixels, such as the red sub-pixel, the green sub-pixel, and the blue sub-pixel.

When the display panel 91 is the liquid crystal display panel, the distance between the first grating panel 94 and the display panel 91 is the distance between the dielectric layer 921 of the first grating panel 94 and the liquid crystal layer 913 of the display panel 91. As shown in FIG. 11, the cell alignment substrate 912, the polarizer POL2, the optical adhesive layer OCA1, and the second substrate 924 of the first grating panel 94 are included between the dielectric layer 921 of the first grating panel 94 and the liquid crystal layer 913 of the display panel 91. The distance between the second grating panel 95 and the display panel 91 is the distance between the dielectric layer 921 of the second grating panel 95 and the liquid crystal layer 913 of the display panel 91. As shown in FIG. 11, the array substrate 911, the polarizer POL3, the optical adhesive layer OCA2, and the first substrate 923 of the second grating panel 95 are included between the dielectric layer 921 of the second grating panel 95 and the liquid crystal layer 913 of the display panel 91.

As shown in FIG. 14, according to the geometric relationship of triangles, it may be obtained:

$$\begin{matrix}\frac{C 1}{2 L} = \frac{h 1}{S} \\ \frac{C 1}{2 P} = \frac{S - h 1}{S} \\ H 1 = h 1 * n \\ \frac{P}{C 1} = \frac{H 2}{H 1 + H 2} \\ \frac{P}{C 2} = \frac{H 1}{H 1 + H 2}\end{matrix}$$

According to the above formula, it may be obtained:

$$\begin{matrix}C 1 = \frac{2 P L}{L + P} \\ H 1 = \frac{S P}{L + P} * n \\ C 2 = \frac{2 P L}{L - P} \\ H 2 = \frac{S P}{L - P} * n\end{matrix}$$

h1 represents the virtual placement height between the first grating panel 94 and the imaging plane 121, and n is the equivalent refractive index of the display device. According to the above formula, the arrangement period C1 of the grating units 93 in the first grating panel 94, the arrangement period C2 of the grating units 93 in the second grating panel 95, the actual placement height H1, and the actual placement height H2 may be calculated.

According to the above formula, in the display device shown in FIG. 11, the arrangement period C1 of the grating units 93 in the first grating panel 94 is less than the arrangement period C2 of the grating units 93 in the second grating panel 95, as shown in FIG. 14.

According to the above formula, in the display device shown in FIG. 11, the distance H1 between the first grating panel 94 and the display panel 91 is less than the distance H2 between the second grating panel 95 and the display panel 91, as shown in FIG. 14.

According to the above formula, a ratio of the distance HI between the first grating panel 94 and the display panel 91 to the distance H2 between the second grating panel 95 and the display panel 91 satisfies the following formula:

$$\frac{H 1}{H 2} = \frac{L - P}{L + P}$$

In some implementations, the dielectric layer 921 may include liquid crystal molecules or the like that can change the transmittance under the action of the electric field. The following is illustrated by an example of the dielectric layer 921 including the liquid crystal molecules.

In some implementations, the driving signal includes a first voltage signal V1 and a second voltage signal V2. As shown in FIG. 16 or FIG. 17, the driving structure 922 includes a first electrode 161 and a second electrode 162. The first electrode 161 is configured to receive the first voltage signal V1, the second electrode 162 is configured to receive the second voltage signal V2, and the first electrode 161 and the second electrode 162 are disposed on two opposite sides of the dielectric layer 921.

In FIGS. 16 and 17, chart a is a schematic diagram of cross-sectional structure of the grating panel, chart b is a schematic planar construction diagram of the second electrode 162, and chart c is a schematic structural diagram of the grating panel.

As shown in FIG. 16 or FIG. 17, the first electrode 161 is provided on a side of the first substrate 923 close to the dielectric layer 921, and the second electrode 162 is provided on a side of the second substrate 924 close to the dielectric layer 921, and the present disclosure is not limited thereto.

In a specific implementation, the first voltage signal V1 is provided to the first electrode 161, and the second voltage signal V2 is provided to the second electrode 162. Since the first electrode 161 and the second electrode 162 are oppositely provided at two sides of the dielectric layer 921, a vertical electric field may be formed between the first electrode 161 and the second electrode 162 so that a deflection angle of the liquid crystal molecules located between the first electrode 161 and the second electrode 162 may be changed, and a light output amount of the light passing through the grating panel 92 may be changed, realizing the light-transmitting or light-shielding of the dielectric layer 921 at the corresponding position.

In some implementations, as shown in FIG. 16 or FIG. 17, a plurality of first electrodes 161 are communicated with each other as an integral structure, and a plurality of second electrodes 162 are arranged along the first direction and are spaced apart from each other.

By applying different second voltage signals V2 to the second electrodes 162 provided at different positions and spaced apart from each other, the grating unit 93 may be finely controlled to form the light-transmitting unit 931 and the light-shielding unit 932.

In some implementations, as shown in FIG. 16 or FIG. 17, the plurality of second electrodes 162 each include a first sub-electrode 163 and a second sub-electrode 164. The first sub-electrode 163 and the second sub-electrode 164 are disposed on different film layers, and in the first direction, an orthographic projection of the first sub-electrode 163 on the display panel 91 and an orthographic projection of the second sub-electrode 164 on the display panel 91 are alternately arranged.

As shown in FIG. 16 or FIG. 17, the first sub-electrode 163 and the second sub-electrode 164 are disposed on a same side of the dielectric layer 921, and in order to avoid a short circuit, a first insulating layer 165 is provided between the first sub-electrode 163 and the second sub-electrode 164.

As shown in FIG. 16 or FIG. 17, the orthographic projections of the first sub-electrode 163 and the second sub-electrode 164 provided adjacently in the first direction on the display panel 91 may partially overlap (overlap region as shown in FIG. 16 or FIG. 17) or may not overlap, which is not limited thereto.

Since the vertical electric field is formed between the second electrode 162 and the first electrode 161, gap-free control of the dielectric layer 921 may be realized by arranging the orthographic projections of the adjacent first sub-electrode 163 and second sub-electrode 164 in the first direction on the display panel 91 partially overlapping, i.e., the adjacent first sub-electrode 163 and second sub-electrode 164 in the first direction partially overlapping along a normal direction of the display panel 91.

In a specific implementation, in the first direction, a width w1 of the first sub-electrode 163 and a width w2 of the second sub-electrode 164 may be the same (as shown in FIG. 16 or FIG. 17) or different, and the width w1 of the first sub-electrode 163 and the width w2 of the second sub-electrode 164 may be selected according to a size of the display panel 91, etc., and the present disclosure is not limited thereto.

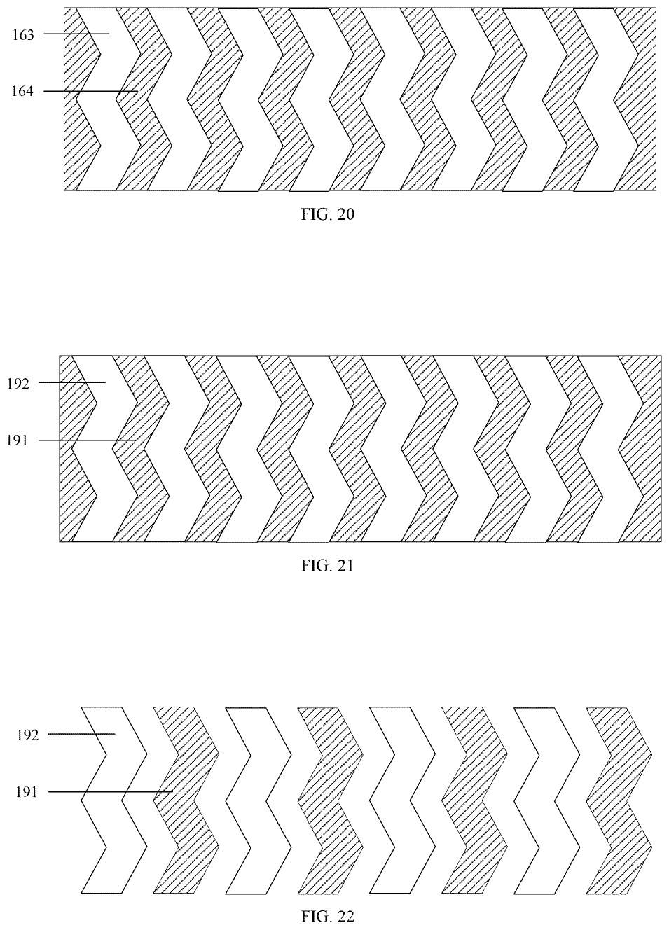

Illustratively, a shape of the orthographic projection of the second electrode 162 on the display panel 91 may be a strip as shown in FIGS. 16 and 17b, a polyline as shown in FIG. 20, or the like. A cross-sectional shape of the second electrode 162 in a direction parallel to the normal line of the display panel 91 may include a rectangle (as shown in FIGS. 16 and 17), a square, a right trapezoid, or an inverted trapezoid, etc.

In a specific implementation, the first sub-electrode 163 may be provided on a side of the second sub-electrode 164 close to the dielectric layer 921 (as shown in FIGS. 16 and 17), or on a side of the second sub-electrode 164 facing away from the dielectric layer 921, and the present disclosure is not limited thereto.

It should be noted that the plurality of second electrodes 162 may be disposed on the same film layer, and the plurality of second electrodes 162 disposed on the same layer need to be spaced apart from each other to avoid a short circuit.

As shown in FIG. 16, in a case where the grating panel 92 is in a normally white mode (namely, light is transmitted when no power is applied, for example, the dielectric layer 921 adopts a twisted nematic (TN) liquid crystal), the first driving signal (namely, a driving signal for driving the dielectric layer 921 to transmit light) includes the same first voltage signal V1 and second voltage signal V2, and the second driving signal (namely, a driving signal for driving the dielectric layer 921 to shield light) includes different first voltage signal V1 and second voltage signal V2. Therefore, in the 3D display stage, the first voltage signal V1 may be provided to the first electrode 161 and may also be provided to the second electrode 162 in the light-transmitting unit 931. Since there is no voltage difference between the first electrode 161 and the second electrode 162, an electric field for driving the deflection of the liquid crystal molecules is not formed so that the liquid crystal molecules at a corresponding position continue to maintain a light-transmitting state, thereby forming the light-transmitting unit 931. The second voltage signal V2 different from the first voltage signal V1 is provided to the second electrode 162 in the light-shielding unit 932. Since there is a voltage difference between the first electrode 161 and the second electrode 162, the electric field for driving the deflection of the liquid crystal molecules may be formed so that the liquid crystal molecules at the corresponding positions are deflected to a light-shielding state, thereby forming the light-shielding unit 932.

As shown in FIG. 17, in a case where the grating panel 92 is in a normally black mode (namely, no light is transmitted when no power is applied, for example, the dielectric layer 921 adopts a vertical alignment (VA) liquid crystal), the first driving signal (namely, the driving signal for driving the dielectric layer 921 to transmit light) includes different first voltage signal V1 and second voltage signal V2, and the second driving signal (namely, the driving signal for driving the dielectric layer 921 to shield light) includes the same first voltage signal V1 and second voltage signal V2. Therefore, in the 3D display stage, the first voltage signal V1 may be provided to the first electrode 161 and may also be provided to the second electrode 162 in the light-shielding unit 932. Since there is no voltage difference between the first electrode 161 and the second electrode 162, the electric field for driving the deflection of the liquid crystal molecules is not formed so that the liquid crystal molecules at the corresponding position continue to maintain the light-shielding state, thereby forming the light-shielding unit 932. The second voltage signal V2 different from the first voltage signal V1 is provided to the second electrode 162 in the light-transmitting unit 931. Since there is a voltage difference between the first electrode 161 and the second electrode 162, the electric field for driving the deflection of the liquid crystal molecules may be formed so that the liquid crystal molecules at the corresponding positions are deflected to the light-transmitting state, thereby forming the light-transmitting unit 931.

In order to make the opening ratio of the grating unit 93 reach 50%, a total number of the second electrodes 162 (i.e., a sum of a number of the first sub-electrodes 163 and the second sub-electrodes 164) located in one grating unit 93 may be an even number n, as shown in FIGS. 16 and 17. In this way, the first voltage signal V1 may be provided to n/2 second electrodes 162, and the second voltage signal V2 different from the first voltage signal V1 may be provided to the other n/2 second electrodes 162 so that half of the grating unit 93 may form the light-transmitting unit 931 and half of the grating unit 93 may form the light-shielding unit 932 to make the opening ratio of the grating unit 93 reaching 50%, thereby improving the display brightness of the display device.

Illustratively, the first grating panel 94 and the second grating panel 95 are shown in FIG. 16 or FIG. 17 (the display device as shown in FIGS. 9 to 11), the number of the second electrodes 162 included in one grating unit 93 in the first grating panel 94 and the number of the second electrodes 162 included in one grating unit 93 in the second grating panel 95 may be the same as or different, and a width of the second electrode 162 in the first grating panel 94 and a width of the second electrode 162 in the second grating panel 95 may be the same or different, and the present disclosure is not limited thereto.

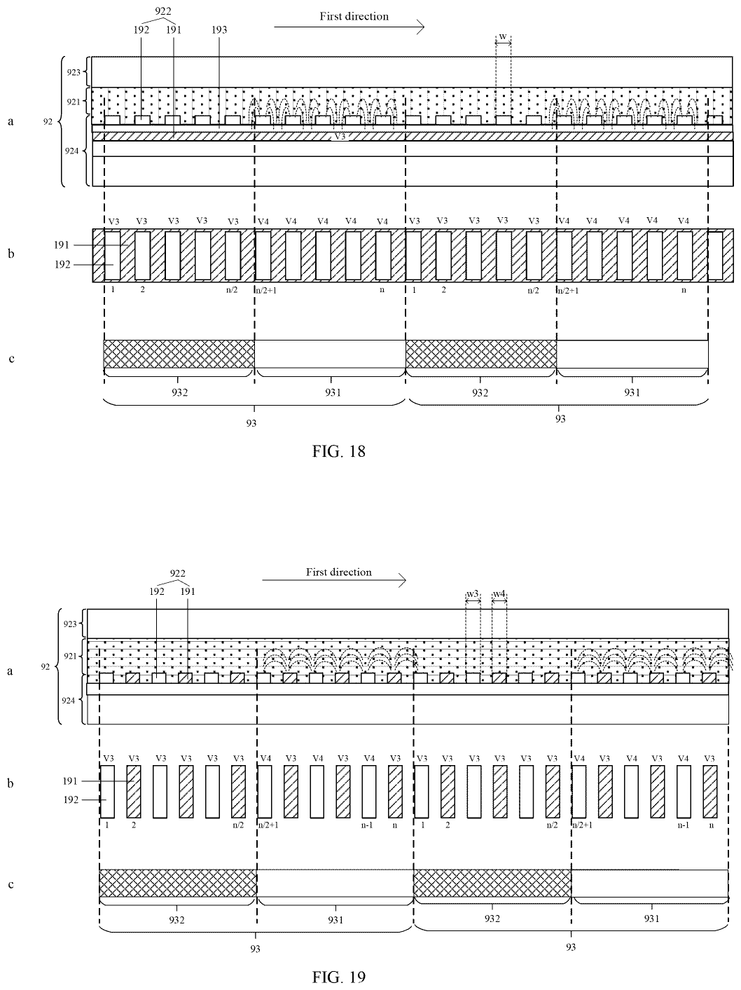

In some embodiments, the driving signal includes a third voltage signal V3 and a fourth voltage signal V4. As shown in FIG. 18 or FIG. 19, the driving structure 922 includes a third electrode 191 and a fourth electrode 192. The third electrode 191 is configured to receive the third voltage signal V3, the fourth electrode 192 is configured to receive the fourth voltage signal V4, and the third electrode 191 and the fourth electrode 192 are disposed on a same side of the dielectric layer 921.

In FIGS. 18 and 19, chart a is a schematic diagram of cross-sectional structure of the grating panel, chart b is a schematic planar construction diagram of the third electrode 191 and the fourth electrode 192, and chart c is a schematic structural diagram of the grating panel.

As shown in FIG. 18 or FIG. 19, the third electrode 191 and the fourth electrode 192 are both provided on a side of the second substrate 924 close to the dielectric layer 921, and the present disclosure is not limited thereto.

In a specific implementation, the third voltage signal V3 is provided to the third electrode 191, and the fourth voltage signal V4 is provided to the fourth electrode 192. Since the third electrode 191 and the fourth electrode 192 are located on the same side of the dielectric layer 921, a horizontal electric field may be formed between the third electrode 191 and the fourth electrode 192 so that a deflection angle of the liquid crystal molecules between the third electrode 191 and the fourth electrode 192 may be changed, and a light output amount of the light passing through the grating panel 92 may be changed, realizing the light-transmitting or light-shielding of the dielectric layer 921.

In some implementations, as shown in FIG. 18, the third electrode 191 and the fourth electrode 192 are disposed in different film layers.

As shown in FIG. 18, a second insulating layer 193 is provided between the third electrode 191 and the fourth electrode 192.

In some implementations, as shown in FIG. 18, multiple third electrodes 191 are communicated with each other as an integral structure, and a plurality of fourth electrodes 192 are arranged along the first direction and are spaced apart from each other within a same film layer.

By applying different fourth voltage signals V4 to the fourth electrodes 192 provided at different positions and spaced apart from each other, the grating unit 93 may be finely controlled to form the light-transmitting unit 931 and the light-shielding unit 932.

Illustratively, a shape of an orthographic projection of the fourth electrode 192 on the display panel 91 may be a strip as shown in FIG. 18, a polyline as shown in FIG. 21, or the like. A cross-sectional shape of the fourth electrode 192 in the direction parallel to the normal line of the display panel 91 may include a rectangle (as shown in FIG. 18), a square, a right trapezoid, or an inverted trapezoid, etc.

In a specific implementation, the fourth electrode 192 may be provided on a side of the third electrode 191 close to the dielectric layer 921 (as shown in FIG. 18), or on a side of the third electrode 191 away from the dielectric layer 921, and the present disclosure is not limited thereto.

It should be noted that the plurality of fourth electrodes 192 may also be located on different film layers, and the present disclosure is not limited thereto.

As shown in FIG. 18, in a case where the grating panel 92 is in the normally black mode (namely, no light is transmitted when no power is applied, for example, the grating panel 92 adopts the advanced super-dimension switch (ADS) technology), the first driving signal (namely, the driving signal for driving the dielectric layer 921 to transmit light) includes different third voltage signal V3 and fourth voltage signal V4, and the second driving signal (namely, the driving signal for driving the dielectric layer 921 to shield light) includes the same third voltage signal V3 and fourth voltage signal V4. Therefore, in the 3D display stage, the third voltage signal V3 may be provided to the third electrode 191 and may also be provided to the fourth electrode 192 in the light-shielding unit 932. Since there is no voltage difference between the third electrode 191 and the fourth electrode 192, an electric field for driving the deflection of the liquid crystal molecules is not formed so that the liquid crystal molecules at a corresponding position continue to maintain the light-shielding state, thereby forming the light-shielding unit 932. The fourth voltage signal V4 different from the third voltage signal V3 is provided to the fourth electrode 192 in the light-transmitting unit 931. Since there is a voltage difference between the third electrode 191 and the fourth electrode 192, the electric field for driving the deflection of the liquid crystal molecules may be formed so that the liquid crystal molecules at the corresponding positions are deflected to the light-transmitting state, thereby forming the light-transmitting unit 931.

In order to make the opening ratio of the grating unit 93 reach 50%, a total number of the fourth electrodes 192 located in one grating unit 93 may be an even number n, as shown in FIG. 18. In this way, the third voltage signal V3 may be provided to n/2 fourth electrodes 192 (e.g., n/2 fourth electrodes 192 located in the light-shielding unit 932), and the fourth voltage signal V4 different from the third voltage signal V3 may be provided to the other n/2 fourth electrodes 192 (e.g., n/2 fourth electrodes 192 located in the light-transmitting unit 931) so that half of the grating unit 93 may form the light-transmitting unit 931 and half of the grating unit 93 may form the shading unit 932 to make the opening ratio of the grating unit 93 reaching 50%, thereby improving the display brightness of the display device.

Illustratively, the first grating panel 94 and the second grating panel 95 are shown in FIG. 18, the number of the fourth electrodes 192 included in one grating unit 93 in the first grating panel 94 and the number of the fourth electrodes 192 included in one grating unit 93 in the second grating panel 95 may be the same or different, and a width w of the fourth electrode 192 in the first grating panel 94 and a width w of the fourth electrode 192 in the second grating panel 95 may be the same or different, and the present disclosure is not limited thereto.

In some implementations, as shown in FIG. 19, the third electrode 191 and the fourth electrode 192 are provide on a same layer.

In some implementations, as shown in FIG. 19, a plurality of third electrodes 191 are arranged along the first direction and are spaced apart from each other, a plurality of fourth electrodes 192 are arranged along the first direction and are spaced apart from each other, and the third electrodes 191 and the fourth electrodes 192 are provided alternately in the first direction.

By applying different fourth voltage signals V4 to the fourth electrodes 192 provided at different positions and spaced apart from each other, the grating unit 93 may be finely controlled to form the light-transmitting unit 931 and the light-shielding unit 932.

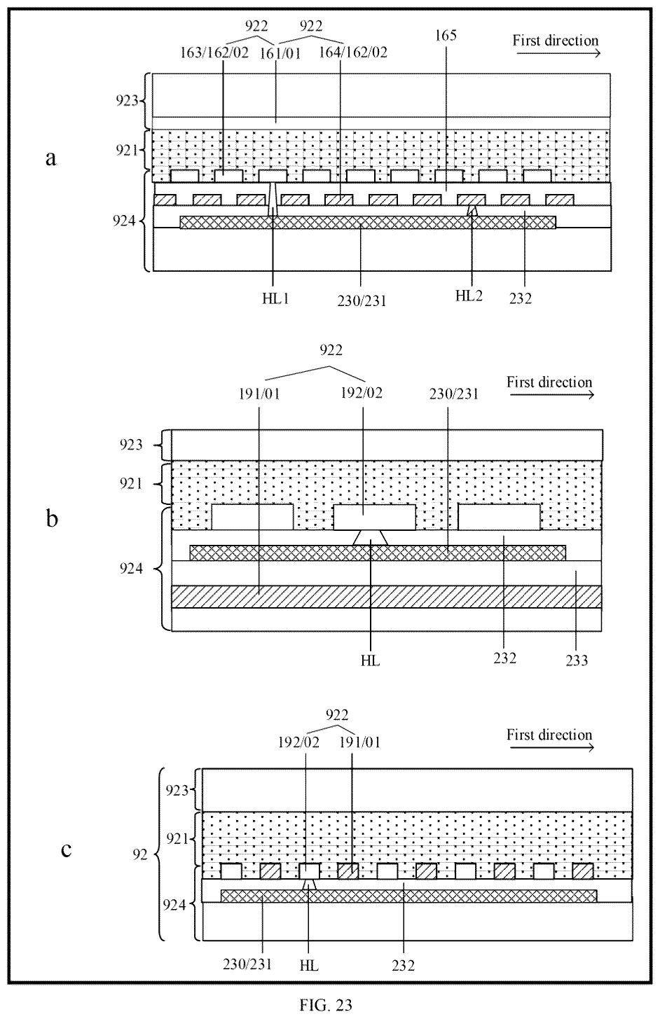

Illustratively, a shape of orthographic projections of the third electrode 191 and the fourth electrode 192 on the display panel 91 may be a strip as shown in FIG. 19, a polyline as shown in FIG. 22, or the like. Cross-sectional shapes of the third electrode 191 and the fourth electrode 192 in the direction parallel to the normal line of the display panel 91 may include a rectangle (as shown in FIG. 19), a square, a right trapezoid, or an inverted trapezoid, etc.

In a specific implementation, in the first direction, a width w3 of the third electrode 191 and a width w4 of the fourth electrode 192 may be the same (as shown in FIG. 19) or different, and the width w3 of the third electrode 191 and the width w4 of the fourth electrode 192 may be set and selected according to the size of the display panel 91, etc., and the present disclosure is not limited thereto.

As shown in FIG. 19, in a case where the grating panel 92 is in the normally black mode (namely, no light is transmitted when no power is applied, for example, the grating panel 92 adopts the in-plane switching (IPS) technology), the first driving signal (namely, the driving signal for driving the dielectric layer 921 to transmit light) includes different third voltage signal V3 and fourth voltage signal V4, and the second driving signal (namely, the driving signal for driving the dielectric layer 921 to shield light) includes the same third voltage signal V3 and fourth voltage signal V4. Therefore, in the 3D display stage, the third voltage signal V3 may be provided to the third electrode 191 and may also be provided to the fourth electrode 192 in the light-shielding unit 932. Since there is no voltage difference between the third electrode 191 and the fourth electrode 192, an electric field for driving the deflection of the liquid crystal molecules is not formed so that the liquid crystal molecules at a corresponding position continue to maintain the light-shielding state, thereby forming the light-shielding unit 932. The fourth voltage signal V4 different from the third voltage signal V3 is provided to the fourth electrode 192 in the light-transmitting unit 931. Since there is a voltage difference between the third electrode 191 and the fourth electrode 192, the electric field for driving the deflection of the liquid crystal molecules may be formed so that the liquid crystal molecules at the corresponding positions are deflected to the light-transmitting state, thereby forming the light-transmitting unit 931.

The third electrode 191 and the fourth electrode 192 in FIG. 19 are both in-plane electrodes as defined below. In order to make the opening ratio of the grating unit 93 reach 50%, a total number of the in-plane electrodes located in one grating unit 93 may be an even number n, as shown in FIG. 19. In this way, a same voltage signal may be provided to n/2 in-plane electrodes, for example, V3, V3, V3 . . . are sequentially provided to n/2 in-plane electrodes located in the light-shielding unit 932. Meanwhile, different voltage signals are alternately provided to the other n/2 in-plane electrodes, for example, V3, V4, V3, V4 . . . are sequentially provided to the n/2 in-plane electrodes located in the light-transmitting unit 931 so that half of the grating unit 93 may form the light-transmitting unit 931 and half of the grating unit 93 may form the shading unit 932 to make the opening ratio of the grating unit 93 reaching 50%, thereby improving the display brightness of the display device.

Illustratively, structures of the first grating panel 94 and the second grating panel 95 are shown in FIG. 19, and the number of the third electrodes 191 included in one grating unit 93 in the first grating panel 94 and the number of the third electrodes 191 included in one grating unit 93 in the second grating panel 95 may be the same or different; the number of the fourth electrodes 192 included in one grating unit 93 in the first grating panel 94 and the number of fourth electrodes 192 included in one grating unit 93 in the second grating panel 95 may be the same or different; a width of the third electrode 191 in the first grating panel 94 and a width of the third electrode 191 in the second grating panel 95 may be the same or different; the width of the fourth electrode 192 in the first grating panel 94 and the width of the fourth electrode 192 in the second grating panel 95 may be the same or different; the present disclosure is not limited thereto.

In a specific implementation, for any one of the grating panels 92, the first substrate 923 may be provided close to the display panel 91 (as shown by the first grating panel 94 and the second grating panel 95 in FIG. 10, and the second grating panel 95 in FIG. 11) or may be provided away from the display panel 91 (as shown by the first grating panel 94 and the second grating panel 95 in FIG. 9, and the first grating panel 94 in FIG. 11), and the present disclosure is not limited thereto.

In some implementations, a total number of the grating units 93 in the first grating panel 94 is the same as a total number of the grating units 93 in the second grating panel 95. The total number of the grating units 93 in the first grating panel 94 and the total number of the grating units 93 in the second grating panel 95 may be determined according to a number of pixel units of the display panel 91 in the first direction and a number of viewpoints, for example, the total number of the grating units 93 in the first grating panel 94 and the total number of the grating units 93 in the second grating panel 95 may be equal to the number of pixel units of the display panel 91 in the first direction divided by the number of viewpoints.

For example, the number of pixel units of the display panel 91 in the first direction is 1280 and the number of viewpoints is 2. Therefore, the total number of the grating units 93 in the first grating panel 94=the total number of the grating units 93 in the second grating panel 95=1280/2=640.

In some implementations, the driving structure 922 includes a common electrode 01 and a driving electrode 02. In FIGS. 16 and 17, the common electrode 01 is the first electrode 161, and the driving electrode 02 is the second electrode 162. In FIGS. 18 and 19, the common electrode 01 is the third electrode 191, and the driving electrode 02 is the fourth electrode 192.

In some implementations, a number of the driving electrodes in one grating unit 93 in the first grating panel 94 may be the same as a number of the driving electrodes in one grating unit 93 in the second grating panel 95. In this way, on the one hand, the design of the grating panel may be simplified, and on the other hand, a same driving algorithm may be adopted to drive the driving structures 922 in the first grating panel 94 and the second grating panel 95, thereby reducing the driving complexity.

Illustratively, the driving electrodes in the first grating panel 94 are ordered along the first direction, the driving electrodes in the second grating panel 95 are ordered along the first direction, and the driving electrodes with a same sequence number in the first grating panel 94 and the second grating panel 95 may be applied with a same voltage.

In some implementations, in a case where the arrangement period C1 of the grating units 93 in the first grating panel 94 is different from the arrangement period C2 of the grating units 93 in the second grating panel 95 and the number of the driving electrodes in one grating unit 93 in the first grating panel 94 is the same as the number of the driving electrodes in one grating unit 93 in the second grating panel 95, a width of the driving electrode in the first grating panel 94 along the first direction is different from a width of the driving electrode in the second grating panel 95 along the first direction.

In some implementations, in a case where the arrangement period C1 of the grating units 93 in the first grating panel 94 is less than the arrangement period C2 of the grating units 93 in the second grating panel 95 and the number of the driving electrodes in one grating unit 93 in the first grating panel 94 is the same as the number of the driving electrodes in one grating unit 93 in the second grating panel 95, the width of the driving electrode in the first grating panel 94 along the first direction is less than a width of the driving electrode in the second grating panel 95 along the first direction.

In FIGS. 16 and 17, the width of the driving electrode along the first direction is the width of the second electrode 162 along the first direction and includes the width w1 of the first sub-electrode 163 and the width w2 of the second sub-electrode 164. In FIG. 18, the width of the driving electrode along the first direction is the width w of the fourth electrode 192 along the first direction. In FIG. 19, the width of the driving electrode along the first direction is the width w3 of the fourth electrode 192 along the first direction.

In some implementations, as shown in FIG. 23, the driving structure 922 includes the common electrode 01 and the driving electrode 02, and a plurality of driving electrodes 02 are arranged at intervals along the first direction. The grating panel further includes a wiring layer 230, disposed on a side of the driving electrode 02 facing away from the dielectric layer 921, and the wiring layer 230 includes a plurality of driving lines 231, at least part of the driving lines 231 being connected to the driving electrode 02 for transmitting the driving signal to the driving electrode 02.

As shown in FIG. 23, a passivation layer 232 is further provided between the wiring layer 230 and the driving electrode 02, and the driving electrode 02 may be connected to the driving line 231 through a via arranged on the passivation layer 232.

The driving structure 922 shown in chart a of FIG. 23 is the same as or similar to the driving structure 922 in FIG. 16 or FIG. 17. The driving electrode 02 is the second electrode 162 and includes the first sub-electrode 163 and the second sub-electrode 164 separated by the first insulating layer 165. As shown in chart a of FIG. 23, the first sub-electrode 163 is connected to the driving line 231 through a via HL1 penetrating the first insulating layer 165 and the passivation layer 232, and the second sub-electrode 164 is connected to the driving line 231 through a via HL2 penetrating the passivation layer 232. In the chart a of FIG. 23, the common electrode 01 is the first electrode 161 and is located on a side of the dielectric layer 921 facing away from the driving electrode 02.

The driving structure 922 shown in chart b of FIG. 23 is the same as or similar to the driving structure 922 in FIG. 18. The driving electrode 02 is the fourth electrode 192. In this case, as shown in chart b of FIG. 23, the fourth electrode 192 is connected to the driving line 231 through a via HL penetrating the passivation layer 232. In chart b of FIG. 23, the common electrode 01 is the third electrode 191 and is located on a side of the wiring layer 230 facing away from the driving electrode 02, and a third insulating layer 233 is further provided between the common electrode 01 and the wiring layer 230.

The driving structure 922 shown in chart c of FIG. 23 is the same as or similar to the driving structure 922 in FIG. 19. The driving electrode 02 is the fourth electrode 192. In this case, as shown in chart c of FIG. 23, the fourth electrode 192 is connected to the driving line 231 through the via HL penetrating the passivation layer 232. In FIG. 23c, the common electrode 01 is the third electrode 191 and is provided on a same layer as the driving electrode 02. The wiring layer 230 may further include a common wiring (not shown in the figure), and the common electrode 01 is lapped with the common wiring through a via penetrating the passivation layer 232.

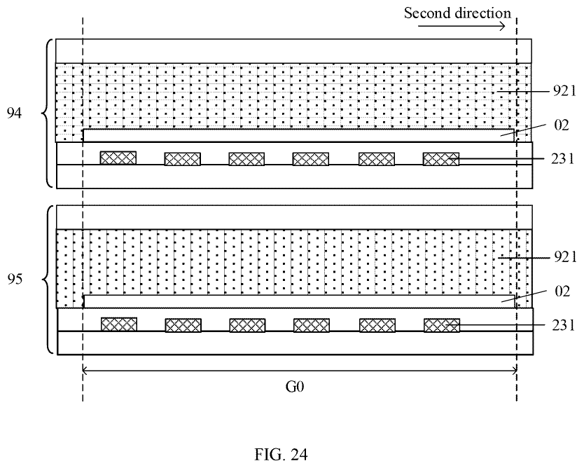

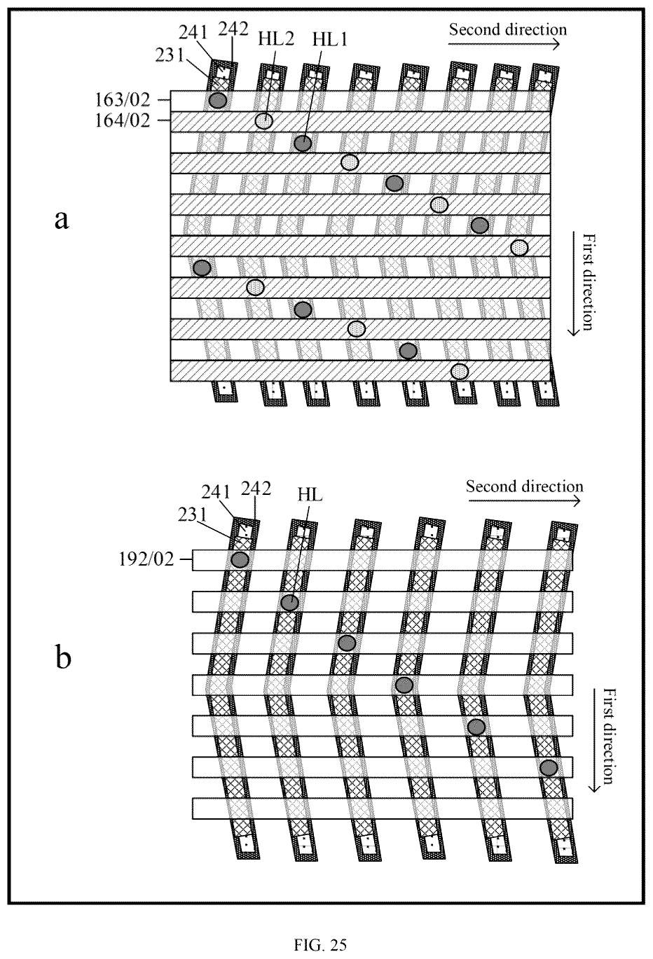

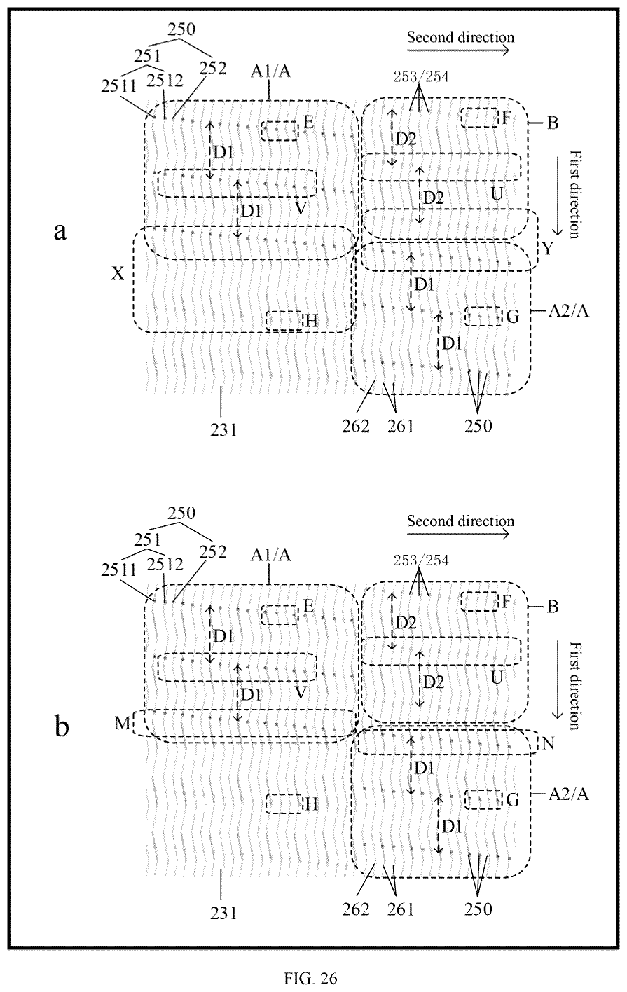

The grating panel includes a grating area G0. Referring to FIG. 25, a partially schematic plan diagram at the grating area is shown. As shown in FIG. 24 or FIG. 25, in the grating area G0, a plurality of driving lines 231 are arranged along a second direction, and an orthographic projection of the driving lines 231 on the display panel intersects with an orthographic projection of the plurality of driving electrodes 02 on the display panel. As shown in FIG. 24, in the second direction, an orthographic projection of the driving lines 231 in the first grating panel 94 on the display panel at least partially overlaps with an orthographic projection of the driving lines 231 in the second grating panel 95 on the display panel. Thus, the transmittance of the grating panel may be increased, the display brightness may be increased, and the power consumption may be reduced.

Further, in the second direction, the orthographic projection of the driving lines 231 in the first grating panel 94 on the display panel completely overlaps with the orthographic projection of the driving lines 231 in the second grating panel 95 on the display panel (as shown in FIG. 24).

In some implementations, as shown in FIG. 25, the display panel includes: a base substrate (not shown in the figure); a plurality of display signal lines 241 disposed on a side of the base substrate and arranged at intervals along the second direction; and a plurality of first light-shielding strips 242 disposed on a side of the plurality of display signal lines 241 close to or facing away from the base substrate and arranged at intervals along the second direction. Chart a of FIG. 25 is a schematic planar construction diagram corresponding to chart a of FIG. 23, and chart b of FIG. 25 is a schematic planar construction diagram corresponding to chart b of FIG. 23.

As shown in charts a or b of FIG. 25, in the second direction, an orthographic projection of the plurality of driving lines 231 on the base substrate at least partially overlaps with an orthographic projection of the plurality of display signal lines 241 on the base substrate, and an orthographic projection of the plurality of first light-shielding strips 242 on the base substrate covers the orthographic projection of the plurality of driving lines 231 on the base substrate. In this way, the first light-shielding strip 242 may be avoided to be visible to the naked eye, improving the display effect.

Illustratively, in the second direction, a width of the driving line 231 is 3-4 um, a width of the display signal line 241 is 3-4 um, and a width of the first light-shielding strip 242 is 5 um.

In some implementations, as shown in FIG. 26, the grating area G0 includes common signal regions A. The driving line 231 located in the common signal region A has a plurality of first switching patterns 250, and the plurality of first switching patterns 250 include first via switching patterns 251 and first virtual switching patterns 252. The first via switching pattern 251 is connected to the driving electrode 02, and the first virtual switching pattern 252 is insulated from the driving electrode 02. The plurality of first switching patterns 250 are evenly arranged at equal intervals in the first direction within the common signal region A.

In a specific implementation, as shown in FIG. 26, the plurality of driving lines 231 include effective driving lines 261 and virtual driving lines 262. The first via switching pattern 251 on the effective driving line 261 is lapped with the driving electrode 02 through the via, and the first virtual switching pattern 252 on the virtual driving line 262 is not lapped with the driving electrode 02 through the via so that the virtual driving line 262 is insulated from the driving electrode 02.

In the second direction, the virtual driving lines 262 may be evenly distributed between the effective driving lines 261. For example, in FIG. 26, one virtual driving line 262 is provided between each two effective driving lines 261, and the present disclosure is not limited thereto.

In some implementations, as shown in FIG. 26, the grating area G0 further includes a functional region B. The driving line 231 located in the functional region B has a plurality of second switching patterns 253, and the plurality of second switching patterns 253 include second virtual switching patterns 254. The second virtual switching pattern 254 is insulated from the driving electrode 02. Within the common signal region A and the functional region B having a corresponding relationship, a plurality of second switching patterns 253 located on a same straight line are obtained by translating a plurality of first switching patterns 250 located on a same straight line along the first direction and/or the second direction. In this way, the uniformity of the distribution of the switching patterns in the grating area may be improved, which helps to improve the display effect.

The common signal region A and the functional region B having a corresponding relationship are the common signal region A and the functional region B corresponding to a same group of driving electrodes 02. The functional region B may be located on one or two sides of the common signal region A in the second direction.

As shown in FIG. 26, a plurality of second switching patterns 253 located in a dashed box U are located on a same straight line, a plurality of first switching patterns 250 located in a dashed box V are located on a same straight line, and the plurality of second switching patterns 253 located in the dashed box U may be obtained by translating the plurality of first switching patterns 250 located in the dashed box V along the first direction and the second direction.

In some implementations, as shown in FIG. 26, the plurality of second switching patterns 253 are evenly arranged at equal intervals in the first direction within the functional region B, and an arrangement period D1 of the plurality of first switching patterns 250 in the first direction is different from an arrangement period D2 of the plurality of second switching patterns 253 in the first direction.

The arrangement period D1 of the plurality of first switching patterns 250 in the first direction may be greater than the arrangement period D2 of the plurality of second switching patterns 253 in the first direction (as shown in FIG. 26), or less than the arrangement period D2 of the plurality of second switching patterns 253 in the first direction.

Illustratively, in FIG. 26, the arrangement period D1 of the plurality of first switching patterns 250 in the first direction is equal to the arrangement period of one grating unit 93 in the first direction, for example, 184.52 μm, and the arrangement period D2 of the plurality of second switching patterns 253 in the first direction is equal to an arrangement period of the pixel unit in the first direction, for example, 184.26 μm.

When the first grating panel 94 and the second grating panel 95 are both provided close to the display side of the display panel 91, in the first direction, since the arrangement period C1 of one grating unit 93 of the first grating panel 94 and the arrangement period C2 of one grating unit 93 of the second grating panel 95 are both less than an arrangement period P of the pixel unit, regardless of the first grating panel 94 or the second grating panel 95, the arrangement period D1 of the plurality of first switching patterns 250 in the first direction is less than the arrangement period D2 of the plurality of second switching patterns 253 in the first direction.

When the first grating panel 94 and the second grating panel 95 are both provided away the display side of the display panel 91, in the first direction, since the arrangement period C1 of one grating unit 93 of the first grating panel 94 and the arrangement period C2 of one grating unit 93 of the second grating panel 95 are both greater than the arrangement period P of the pixel unit, regardless of the first grating panel 94 or the second grating panel 95, the arrangement period D1 of the plurality of first switching patterns 250 in the first direction is greater than the arrangement period D2 of the plurality of second switching patterns 253 in the first direction.

When the first grating panel 94 is provided close to the display side of the display panel 91, and the second grating panel 95 is provided away from the display side of the display panel 91, in the first direction, since the arrangement period C1 of one grating unit 93 of the first grating panel 94 is less than the arrangement period P of the pixel unit, and the arrangement period C2 of one grating unit 93 of the second grating panel 95 is greater than the arrangement period P of the pixel unit, for the first grating panel 94, the arrangement period D1 of the plurality of first switching patterns 250 in the first direction is less than the arrangement period D2 of the plurality of second switching patterns 253 in the first direction; and for the second grating panel 95, the arrangement period D1 of the plurality of first switching patterns 250 in the first direction is greater than the arrangement period D2 of the plurality of second switching patterns 253 in the first direction.

Since the arrangement period D1 of the plurality of first switching patterns 250 in the first direction is different from the arrangement period D2 of the plurality of second switching patterns 253 in the first direction, a density of the switching patterns may be greater than, less than, or equal to a density of the switching patterns in the common signal region A at an intersection position of the common signal region A and the functional region B in the first direction. The density of the switching patterns may be greater than, less than, or equal to a density of the switching patterns in the functional region B at the intersection position of the common signal region A and the functional region B in the first direction.

The patching pattern may include at least one of the first via switching pattern 251, the first virtual switching pattern 252, and the second virtual switching pattern 254.

For example, in Chart a of FIG, 26, the dashed box X and the dashed box Y are both located at the intersection position of the common signal region A and the functional region B. A density of the switching patterns in the dashed box X is less than the density of the switching patterns in the common signal region A and the density of the switching patterns in the functional region B. A density of the switching patterns in the dashed box Y is greater than the density of the switching patterns in the common signal region A and the density of the switching patterns in the functional region B.

It should be noted that the arrangement period D1 of the plurality of first switching patterns 250 in the first direction may also be equal to the arrangement period D2 of the plurality of second switching patterns 253 in the first direction, and the present disclosure is not limited thereto. Further, the plurality of second switching patterns 253 located on the same straight line and the plurality of first switching patterns 250 located on the same straight line may be located on the same straight line, and an extension direction of the straight line may be along or intersect with the first direction, and the present disclosure is not limited thereto.

In some implementations, as shown in Chart b of FIG. 26, the grating area G0 includes a plurality of common signal regions A. Two common signal regions adjacent in the first direction are a first common signal region A1 and a second common signal region A2. A plurality of first switching patterns 250 (located in a dashed box M) in the first common signal region A1 close to the second common signal region A2 are located substantially on a same straight line as a plurality of first switching patterns 250 (located in a dashed box N) in the second common signal region A2 close to the first common signal region A1.

It should be noted that the above-mentioned substantially located on a same straight line refers to: the plurality of first switching patterns 250 (located in the dashed box M) in the first common signal region A1 close to the second common signal region A2 and the plurality of first switching patterns 250 (located in the dashed box N) in the second common signal region A2 close to the first common signal region A1 may be located on exactly the same straight line or may be located approximately on the same straight line within an acceptable deviation.

First via switching patterns 251 in the plurality of first switching patterns 250 (located in the dashed box M) in the first common signal region A1 close to the second common signal region A2 are connected to the driving electrode 02 in the same grating unit 93, and first via switching patterns 251 in the plurality of first switching patterns 250 (located in the dashed box N) in the second common signal region A2 close to the first common signal region A1 is connected to the driving electrode 02 in the same grating unit 93.

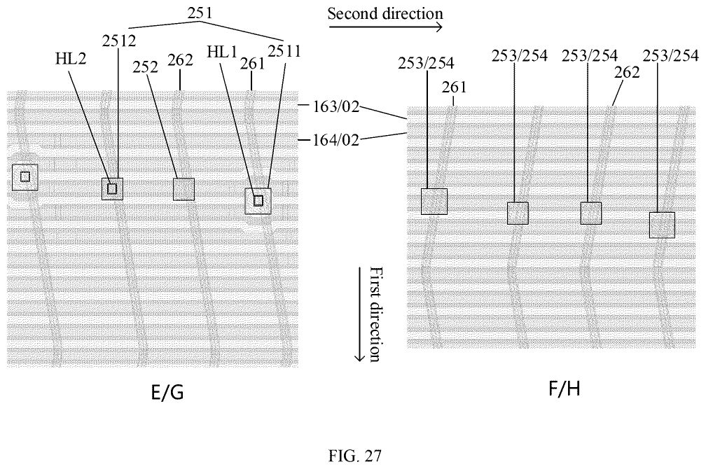

In some implementations, referring to FIG. 27, an enlarged schematic diagram at dashed boxes E, F, G, and H in FIG. 26 is shown. As shown in the left diagram of FIG. 27, a size of an orthographic projection of the first via switching pattern 251 on the display panel may be greater than or equal to a size of an orthographic projection of the first virtual switching pattern 252 on the display panel.

As shown in the left diagram of FIG. 27, a plurality of first via switching patterns 251 include first sub-via switching patterns 2511 and second sub-via switching pattern 2512. The first sub-via switching pattern 2511 is connected to the first sub-electrode 163 through the via HL1 penetrating the first insulating layer 165 and the passivation layer 232, and the second sub-via switching pattern 2512 is connected to the second sub-electrode 164 through the via HL2 penetrating the passivation layer 232.

To avoid poor lap at the vias, in some implementations, a size of an orthographic projection of the first sub-via switching pattern 2511 on the display panel is greater than a size of an orthographic projection of the second sub-via switching pattern 2512 on the display panel, and a size of an orthographic projection of the second sub-via switching pattern 2512 on the display panel is greater than or equal to the size of the orthographic projection of the first virtual switching pattern 252 on the display panel, as shown in the left diagram of FIG. 27.

In a specific implementation, the grating panel 92 includes the grating area G0, and a non-grating area located on at least one side of the grating area G0. The display panel 91 includes an effective display area, and a non-display area located on at least one side of the effective display area. An orthographic projection of the grating area G0 on a plane where the display panel is located covers the effective display area.

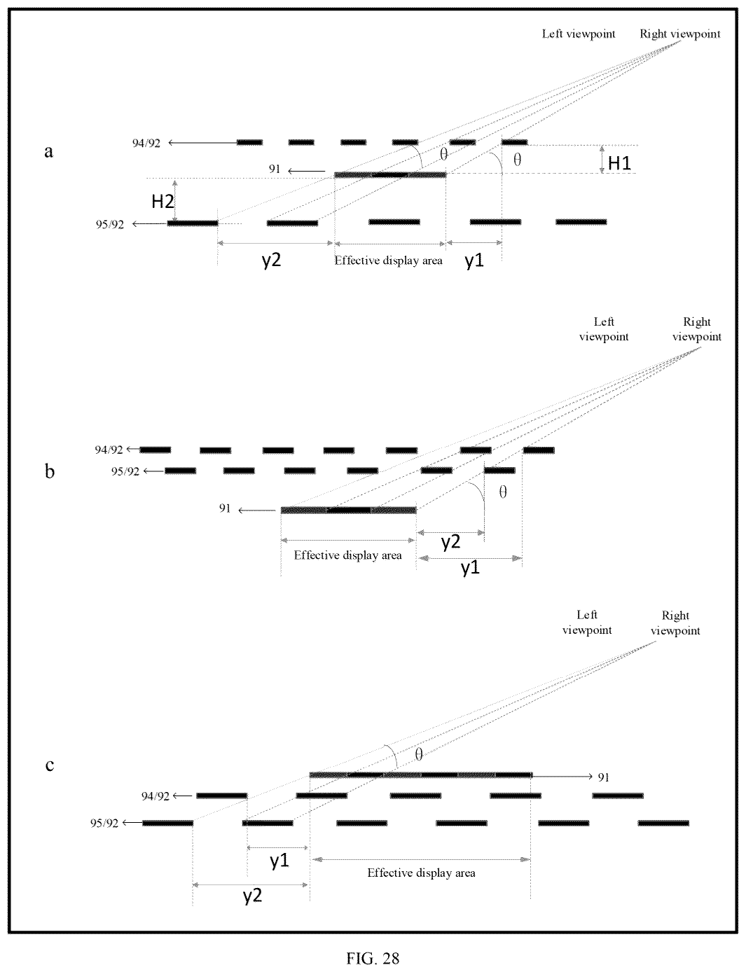

In some implementations, as shown in FIG. 28, in the first direction, an orthographic projection of a grating area G0 of the first grating panel 94 on the display panel covers the effective display area of the display panel 91, and an orthographic projection of a grating area G0 of the second grating panel 95 on the display panel 91 covers the effective display area. In this way, it is possible to view 3D images from the side viewing angle.

In Chart a of FIG. 28, considering the user's actual viewing scene, there is a side-view viewing demand, and a maximum allowable side-view viewing angle is assumed to be θ. For the first grating panel 94, there is tan(θ)=H1/y1, which yields y1=H1/tan(θ). H1 represents a distance between the display panel 91 and the first grating panel 94, and y1 represents a value that a boundary of the grating area of the first grating panel 94 needs to exceed a boundary of the effective display area of the display panel 91.

For the second grating panel 95, there is tan(θ)=H2/y2, which yields y2=H2/tan(θ). H2 represents a distance between the display panel 91 and the second grating panel 95, and y2 represents a value that a boundary of the grating area of the second grating panel 95 needs to exceed the boundary of the effective display area of the display panel 91.

As shown in chart a and chart c of FIG. 28, the distance between the second grating panel 95 and the display panel 91 is greater than the distance between the first grating panel 94 and the display panel 91, and the distance y2 in the first direction between a boundary of the orthographic projection of the grating area G0 of the second grating panel 95 on the display panel 91 and a boundary of the effective display area is greater than the distance y1 in the first direction between a boundary of the orthographic projection of the grating area G0 of the first grating panel 94 on the display panel 91 and the boundary of the effective display area.

As shown in chart b of FIG. 28, the distance between the first grating panel 94 and the display panel 91 is greater than the distance between the second grating panel 95 and the display panel 91, and the distance y1 in the first direction between the boundary of the orthographic projection of the grating area G0 of the first grating panel 94 on the display panel 91 and the boundary of the effective display area is greater than the distance y2 in the first direction between the boundary of the orthographic projection of the grating area G0 of the second grating panel 95 on the display panel 91 and the boundary of the effective display area.

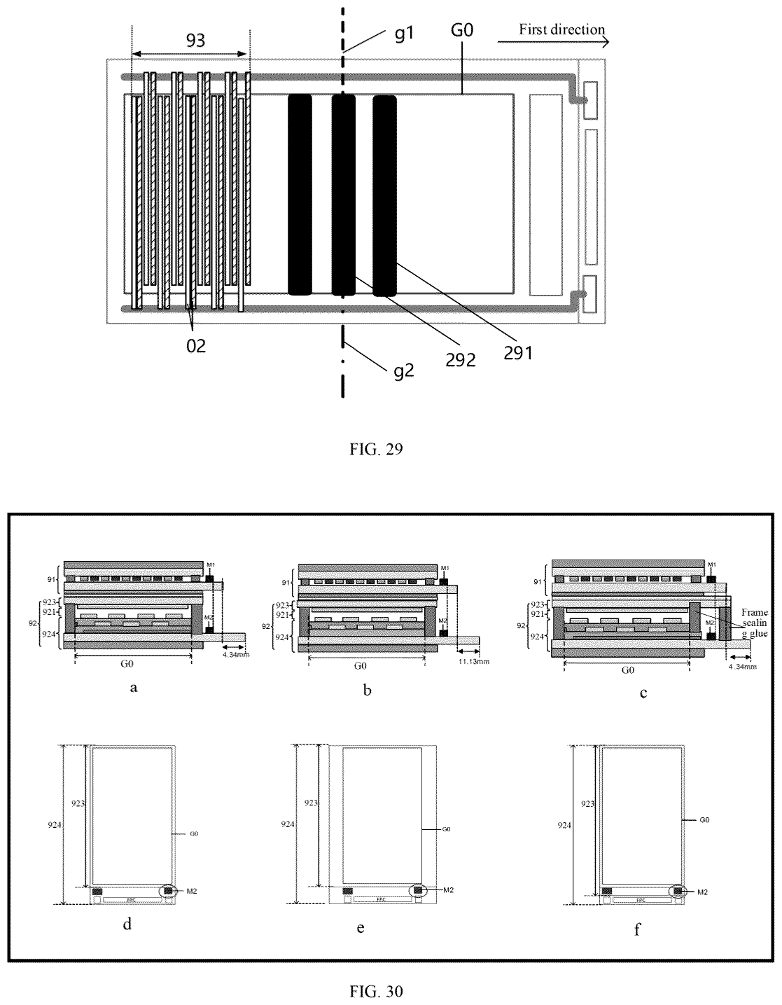

In some implementations, as shown in FIG. 29, the display panel 91 further includes a plurality of second light-shielding strips 291 arranged along the first direction. In the first direction, the second light-shielding strip 291 located in the middle of the plurality of second light-shielding strips 291 is a central light-shielding strip 292. In the first direction, a center g1 of the grating area of the grating panel 92 coincides with a center g2 of the central light-shielding strip 292 so that an optimal viewing angle shift may be avoided and the display effect may be improved.

In some implementations, a ratio between the transmittance of the at least two grating panels and a thickness of the driving electrode 02 is greater than or equal to 1.3*10⁸ Å⁻¹ and less than or equal to 2.86*10⁻⁸ Å⁻¹ in a state where all of the dielectric layers in the grating panels are in the light-shielding state. When the above-mentioned ratio is less than 1.3*10⁻⁸ Å⁻¹, it may result in a large difference in driving voltages of different driving electrodes, thereby resulting in a large difference in the transmittance and affecting the display effect. When the above-mentioned ratio is greater than 2.86*10⁻⁸ Å⁻¹, it may result in a poor charging rate of the driving electrode, affecting the display effect.

The thickness of the driving electrode 02 may be greater than or equal to 700 Å and less than or equal to 1500 Å. A thickness of the driving line 231 may be greater than or equal to 1000 Å and less than or equal to 5000 Å. A thickness of the passivation layer 232 may be, for example, greater than or equal to 1000 Å and less than or equal to 3000 Å. A thickness of the third insulating layer 233 may be, for example, greater than or equal to 2000 Å and less than or equal to 4000 Å.

The common electrode 01 and the driving electrode 02 may be made of a transparent conductive material such as indium tin oxide. The driving line 231 may be made of one or more metals such as copper, aluminum, molybdenum, and silver.

In some implementations, referring to FIG. 30, a first alignment mark M1 is provided in a non-effective display area of the display panel 91, and a second alignment mark M2 is provided in the non-grating area of the grating panel 92. Assembly of the display panel 91 and the grating panel 92 may be realized by aligning the first alignment mark M1 and the second alignment mark M2.

In FIG. 30, chart a, chart b, and chart c are cross-sectional structural diagrams of three structures, chart d is a schematic plan diagram of chart a, chart e is a schematic plan diagram of chart b, and chart f is a schematic plan diagram of chart c.

In a specific implementation, the second alignment mark M2 may be located in a single layer area. As shown in chart a, b, d, and e in FIG. 30, the second alignment mark M2 is provided on a side of the second substrate 924 close to the first substrate 923, and an orthographic projection of the first substrate 923 on the second substrate 924 does not cover the second alignment mark M2. In this case, since the second alignment mark M2 is not shielded by the first substrate 923, the alignment accuracy of the display panel 91 and the grating panel 92 may be improved.

In a specific implementation, the non-grating area of the grating panel 92 is set to be large in size in some cases to meet the spatial arrangement requirements of a large number of wirings, and the second alignment mark M2 may be located in a dual layer area. As shown in chart c and f in FIG. 30, the second alignment mark M2 is provided on a side of the second substrate 924 close to the first substrate 923, and the orthographic projection of the first substrate 923 on the second substrate 924 covers the second alignment mark M2. In this case, since a size of the second substrate 924 exceeding the first substrate 923 is small, i.e., an exposed range of the second substrate 924 is small, poor debris may be effectively reduced. Meanwhile, since the second alignment mark M2 is shielded by the first substrate 923, the alignment accuracy of the display panel 91 and the grating panel 92 may be reduced.

As shown in chart c of FIG. 30, the second alignment mark M2 is located inside a frame sealing glue, and the frame sealing glue is configured to encapsulate the first substrate 923 and the second substrate 924.

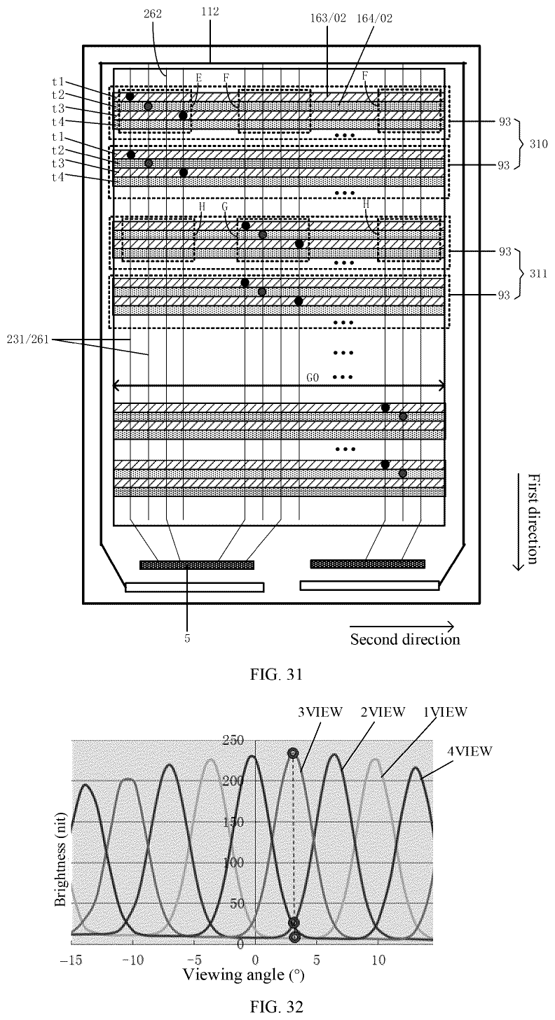

As shown in FIG. 31, the driving lines 231 are connected to a signal input terminal (not shown in the figure, which may be located in a region covered by a driving chip 5 in FIG. 31) and the driving electrode 02 for transmitting a driving signal inputted from the signal input terminal to the driving electrode 02.

As shown in FIG. 31, the grating area G0 of the grating panel 92 may include a plurality of common signal units 310. The common signal unit 310 includes at least one grating unit 93, and the grating unit 93 includes a plurality of driving electrodes 02. A plurality of driving electrodes 02 located in a same grating unit 93 are connected to different driving lines 231.

As shown in FIG. 31, the plurality of driving electrodes 02 located in the same grating unit 93 are ordered along the first direction, and driving electrodes 02 located in a same common signal unit 310 and having the same sequence number are connected to a same driving line 231. Driving electrodes with the same sequence number in different common signal units 310 are provided with driving signals by different driving lines 231, and thus the driving signals thereof may be the same or different.

An orthographic projection of the driving lines 231 on the display panel 91 may be a straight line structure (as shown in FIG. 31) or a polyline structure (as shown in FIGS. 25 and 26), and the present disclosure is not limited thereto.

In a specific implementation, the virtual driving line 262 is insulated from the driving electrode 02 and may be connected to a reference voltage line 112 located in the non-grating area.

As shown in FIG. 31, in each grating unit 93, a plurality of driving electrodes 02 are ordered along the first direction, and the driving electrodes 02 with the sequence numbers of 1, 2, 3 . . . n are marked as t1, t2, t3 . . . tn. In a same common signal unit 310, the driving electrodes 02 with a same sequence number are connected to a same driving line 231, for example, the driving electrodes 02 marked t1 are connected to a same driving line 231, the driving electrodes 02 marked 12 are connected to a same driving line 231, the driving electrodes 02 marked 13 are connected to a same driving line 231, and the driving electrodes 02 marked 14 are connected to a same driving line 231.

In FIG. 31, since the driving line 231 is provided in the grating area G0, it is only necessary to provide the signal input terminal on one side (a lower side as shown in FIG. 31) of the grating area G0, and no wiring is required at a left side, a right side, and an upper side of the grating area G0 so that a three-side narrow frame may be realized.

In FIG. 26, the first via switching patterns 251 located in the same common signal region A are correspondingly connected to the driving electrodes 02 in one common signal unit 310, and in the common signal region A, the first via switching patterns 251 located on one straight line are connected to the driving electrodes 02 in one grating unit 93.

In the above, the common signal region A and the functional region B having a corresponding relationship are the common signal region A and the functional region B corresponding to the same common signal unit 310.

In some implementations, as shown in any one of FIGS. 9 to 11, the display panel 91 is the liquid crystal display panel. In this case, the first grating panel 94 and the second grating panel 95 may be stacked on the same or opposite sides of the display panel 91.

In some implementations, as shown in any one of FIGS. 9 to 11, the display panel 91 is the liquid crystal display panel. The adjacent display panel 91 and grating panel 92 may share one polarizer, and two adjacent grating panels 92 may also share one polarizer.

Illustratively, in FIG. 9, the display panel 91 and the second grating panel 95 share the polarizer POL3, and the first grating panel 94 and the second grating panel 95 share the polarizer POL2. Orientation layers are provided on sides of the cell alignment substrate 912 and the array substrate 911 close to the liquid crystal layer 913, and orientation layers are provided on sides of the first substrate 923 and the second substrate 924 close to the dielectric layer 912. The material of the dielectric layer 912 is liquid crystal. A rubbing direction of the orientation layer in the cell alignment substrate 912 is the first direction (namely, a 0° direction), and a rubbing direction of the orientation layer in the array substrate 911 is the second direction (namely, a 90° direction, perpendicular to the first direction). Accordingly, an absorption axis angle of a polarizer POL4 is 90°, an absorption axis angle of the polarizer POL3 is 0°, an absorption axis angle of the polarizer POL2 is 90°, and an absorption axis angle of a polarizer POL1 is 0°. Accordingly, in the second grating panel 95, a rubbing direction of the orientation layer in the second substrate 924 is the 0° direction, and a rubbing direction of the orientation layer in the first substrate 923 is the 90° direction. In the first grating panel 94, a rubbing direction of the orientation layer in the second substrate 924 is the 90° direction, and a rubbing direction of the orientation layer in the first substrate 923 is the 0° direction.

Illustratively, in FIG. 10, the display panel 91 and the first grating panel 94 share the polarizer POL2, and the first grating panel 94 and the second grating panel 95 share the polarizer POL3. Orientation layers are provided on sides of the cell alignment substrate 912 and the array substrate 911 close to the liquid crystal layer 913, and orientation layers are provided on sides of the first substrate 923 and the second substrate 924 close to the dielectric layer 912. The material of the dielectric layer 912 is liquid crystal. A rubbing direction of the orientation layer in the cell alignment substrate 912 is the first direction (namely, a 0° direction), and a rubbing direction of the orientation layer in the array substrate 911 is the second direction (namely, a 90° direction, perpendicular to the first direction). Accordingly, an absorption axis angle of the polarizer POL1 is 0°, an absorption axis angle of the polarizer POL2 is 90°, an absorption axis angle of the polarizer POL3 is 0°, and an absorption axis angle of the polarizer POL4 is 90°. Accordingly, in the first grating panel 94, a rubbing direction of the orientation layer in the first substrate 923 is the 90° direction. and a rubbing direction of the orientation layer in the second substrate 924 is the 0° direction. In the second grating panel 95, a rubbing direction of the orientation layer in the first substrate 923 is the 0° direction, and a rubbing direction of the orientation layer in the second substrate 924 is the 90° direction.

Illustratively, in FIG. 11, the display panel 91 and the first grating panel 94 share the polarizer POL2, and the display panel 91 and the second grating panel 95 share the polarizer POL3. Orientation layers are provided on sides of the cell alignment substrate 912 and the array substrate 911 close to the liquid crystal layer 913, and orientation layers are provided on sides of the first substrate 923 and the second substrate 924 close to the dielectric layer 912. The material of the dielectric layer 912 is liquid crystal. A rubbing direction of the orientation layer in the cell alignment substrate 912 is the first direction (namely, a 0° direction), and a rubbing direction of the orientation layer in the array substrate 911 is the second direction (namely, a 90° direction, perpendicular to the first direction). Accordingly, an absorption axis angle of the polarizer POL1 is 90°, an absorption axis angle of the polarizer POL2 is 0°, an absorption axis angle of the polarizer POL3 is 90°, and an absorption axis angle of the polarizer POL4 is 0°. Accordingly, in the first grating panel 94, a rubbing direction of the orientation layer in the first substrate 923 is the 90° direction. and a rubbing direction of the orientation layer in the second substrate 924 is the 0° direction. In the second grating panel 95, a rubbing direction of the orientation layer in the first substrate 923 is the 90° direction, and a rubbing direction of the orientation layer in the second substrate 924 is the 0° direction.

In some implementations, the display panel 91 includes a light-emitting device, and the light-emitting device includes at least one of: an organic light-emitting diode (OLED), a quantum dot light-emitting diode (QLED), a mini light-emitting diode (Mini LED), or a micro light-emitting diode (Micro LED), etc., and the present disclosure is not limited thereto. In this case, the first grating panel 94 and the second grating panel 95 are located on the display side of the display panel 91.

In some implementations, the display device is a 3D display device, and the 3D display device may further include: an eyeball tracking module, configured to acquire a viewing distance; and a driving module, connected to the eyeball tracking module and the driving structure 922 and configured to adjust a position and a size of the light-transmitting unit 931 in the grating unit 93 according to the viewing distance.

The above-mentioned eyeball tracking module may include a sensor device such as a camera, and the driving module may parse out information such as an eyeball position according to shooting information of the eyeball tracking module and relevant eyeball tracking technologies to acquire the viewing distance and adjust the opening position and/or opening ratio of the grating unit 93 in real time, thereby matching the moved viewpoint position as much as possible, reducing the crosstalk phenomenon occurring during the movement, and improving the user experience and product quality.

The camera may be provided on the display side of the display panel 91.

In some implementations, the display device is the 3D display device, and a crosstalk value between different viewpoint pictures of the 3D display device is less than or equal to 0.2%. Referring to FIG. 32, according to the white light brightness distribution curve of each view (namely, an image corresponding to each viewpoint, such as 1VIEW, 2VIEW, 3VIEW, and 4VIEW in FIG. 32) under different viewing angles, the crosstalk value may be calculated using the following formula:

$$P C T = K \times \frac{{L}_{all} - {L}_{i}}{{L}_{i}} \times 100 \%$$

PCT represents the crosstalk value, Lᵢ represents the peak brightness of a main view (such as the third view 3VIEW) at an optimal viewing angle position, Lₐₗₗ represents the total brightness of other views (such as 1VIEW, 2VIEW, and 4VIEW in FIG. 32) at the optimal viewing angle position, K represents a comprehensive influence factor, and a numerical value thereof is related to the perception of the naked-eye stereoscopic display by the human eye and the influence of each view on the main view, and the numerical value of K, for example, may be 1.

The display device provided by the present disclosure may be a product having an image display function. For example, the display device may be any one of a display, a television, a billboard, a digital photo frame, a laser printer with a display function, a telephone, a mobile phone, a personal digital assistant (PDA), a digital camera, a portable camcorder, a viewfinder, a navigator, a vehicle, a large-area wall, a household appliance, an information query device (such as a business query device of a department such as e-government, a bank, a hospital, and electric power), and a monitor, etc. The display device may also be a microdisplay or a product including a microdisplay. The product including the microdisplay may be any one of a smart watch, a smart bracelet, a helmet-mounted display, a stereoscopic display mirror, and an AR apparatus, etc.

The present disclosure provides a driving method of a display device, applied to the display device as provided in any implementation. The display device includes the display panel 91 and at least two grating panels 92. The grating panel 92 includes a plurality of grating units 93, and a driving method of the grating unit 93 includes:
S01: in the 2D display stage, providing the first driving signal to all driving structures 922 located in the same grating unit 93 to drive the corresponding position of the dielectric layer 921 to transmit light so that the entire grating unit 93 forms the light-transmitting unit 931; and
S02: in the 3D display stage, providing the first driving signal to a part of the driving structures 922 located in the same grating unit 93 to drive a corresponding position of the dielectric layer 921 to transmit light, and providing the second driving signal to another part of the driving structures 922 located in the same grating unit 93 to drive a corresponding position of the dielectric layer 921 to shield light so that the grating units 93 form the light-transmitting unit 931 and the light-shielding unit 932.

In a specific implementation, the driving structure 922 includes the common electrode and the driving electrode. Illustratively, in FIGS. 16 and 17, the common electrode is the first electrode 161, and the driving electrode is the second electrode 162. In FIGS. 18 and 19, the common electrode is the third electrode 191, and the driving electrode is the fourth electrode 192.

In some implementations, in S01 and S02, the providing the first driving signal to the driving structures 922 includes:
S11: in the normally black mode, providing different voltage signals to the common electrode and the driving electrode to drive the corresponding position of the dielectric layer 921 to transmit light; and
S12: in the normally white mode, providing the same voltage signal to the common electrode and the driving electrode to drive the corresponding position of the dielectric layer 921 to transmit light.

In some implementations, in step S02, the providing the second driving signal to the driving structures 922 includes:
S21: in the normally black mode, providing the same voltage signal to the common electrode and the driving electrode to drive the corresponding position of the dielectric layer 921 to shield light; and
S22: in the normally white mode, providing different voltage signals to the common electrode and the driving electrode to drive the corresponding position of the dielectric layer 921 to shield light.

It should be noted that the driving method may include more steps, which may be determined according to actual requirements, and the present disclosure is not limited thereto. A detailed description and technical effects of the driving method may be referred to the above description of the display device, which will not be repeated here.

In this disclosure, “plurality” means two or more, and “at least one” means one or more, unless otherwise explicitly and specifically limited.

In the description of the present disclosure, it should be understood that orientation or positional relationships indicated by terms “upper”, “lower”, “front”, “rear”, “left”, “right” etc. are based on those shown in the accompanying drawings. The orientation or positional relationships are only for the convenience of describing the present disclosure and simplifying the description, and do not indicate or imply that the referred device or element must have a specific orientation, be constructed and operated in a specific orientation, and thus cannot be construed as limiting the present disclosure.

The terms “comprising”, “including” or any other variation thereof are intended to cover a non-exclusive inclusion, such that a process, method, article, or apparatus including a list of elements includes not only those elements but also other elements not expressly listed, or elements inherent to the process, method, article or apparatus. Without further limitations, an element defined by the phrase “comprising a . . . ” does not exclude the presence of additional identical elements in the process, method, article or apparatus including said element.

References to “one embodiment,” “some embodiments,” “exemplary embodiments,” “one or more embodiments,” “examples,” “one example,” “some examples” and the like are intended to indicate specific features, structures, materials, or characteristics associated with the embodiment or example are included in at least one embodiment or example of the present disclosure. Schematic representations of the above terms do not necessarily referring to the same embodiment or example. Furthermore, the particular features, structures, materials or characteristics described may be included in any suitable manner in any one or more embodiments or examples.

Herein, relational terms such as “first” and “second” are used merely to distinguish an entity or operation from another entity or operation, and do not necessarily require or imply the existence of any such actual relationship or sequence between these entities or operations.

Expressions “coupled” and “connected” may be used when describing some embodiments. For example, the term “connected” may be used in some embodiments to indicate that two or more components are in direct physical or electrical contact with each other. As another example, the term “coupled” may be used when describing some embodiments to indicate that two or more components are in direct physical or electrical contact. However, the terms “coupled” or “communicatively coupled” may also refer to two or more components that are not in direct contact with each other but still cooperate or interact with each other. The embodiments disclosed herein are not necessarily limited by the content herein.

“At least one of A, B and C” has the same meaning as “at least one of A, B or C” and includes the following combinations of A, B and C: only A; only B; only C; a combination of A and B; a combination of A and C; a combination of B and C, and a combination of A, B and C.

“A and/or B” includes the following three combinations: only A; only B, and a combination of A and B.

As used herein, the term “if” is optionally interpreted to mean “when” or “in response to” or “in response to determining” or “in response to detecting,” depending on the context. Similarly, depending on the context, the phrase “if it is determined . . . ” or “if [stated condition or event] is detected” is optionally interpreted to mean “when it is determined . . . ” or “in response to the determination . . . ” or “on detection of [stated condition or event]” or “in response to detection of [stated condition or event]”.

The use of “for” or “configured to” in this document means open and inclusive language that does not exclude devices that are adapted to or configured to perform additional tasks or steps.

The use of “based on” or “according to” in this article implies openness and inclusiveness. Processes, steps, calculations or other actions based on one or more of the stated conditions of values may in practice be based on other conditions or exceed the stated values. Processes, steps, calculations or other actions based on one or more of the stated conditions or values may in practice be based on other conditions or exceed the stated values.

As used herein, “about,” “approximately,” or “approximately” includes the stated value as well as an average within an acceptable range of deviations from the particular value, as determined by one of ordinary skill in the art. Determined taking into account the measurement in question and the errors associated with the measurement of the specific quantity (i.e., the limitations of the measurement system).

As used herein, “parallel”, “perpendicular”, “equal” and “flush” include the stated conditions as well as approximations of the stated conditions within the acceptable deviation range. range, where the acceptable deviation range is as determined by one of ordinary skill in the art taking into account the measurement in question and the errors associated with the measurement of the particular quantity (i.e., the limitations of the measurement system). For example, “parallel” includes absolutely parallel and approximately parallel, and the acceptable deviation range of approximately parallel may be, for example, a deviation within 5°; “perpendicular” includes absolutely vertical and approximately vertical, and the acceptable deviation range of approximately vertical may also be, for example, Deviation within 5°. “Equal” includes absolute equality and approximate equality, wherein the difference between the two that may be equal within the acceptable deviation range of approximately equal is less than or equal to 5% of either one, for example. “Flush” includes absolute flush and approximately flush, wherein the acceptable deviation range of the approximate flush, for example, the distance between the two that may be flush is less than or equal to 5% of any one of the dimensions.

It will be understood that when a layer or element is referred to as being on another layer or substrate, this can mean that the layer or element is directly on the other layer or substrate, or that the layer or element can be coupled to the other layer or substrate There is an intermediate layer in between.

Example embodiments are described herein with reference to cross-sectional illustrations and/or plan views that are idealized illustrations. In the drawings, the thickness of layers and regions are exaggerated for clarity. Accordingly, variations from the shapes in the drawings due, for example, to manufacturing techniques and/or tolerances are contemplated. Thus, example embodiments should not be construed as limited to the shapes of regions illustrated herein but are to include deviations in shapes that result from, for example, manufacturing. For example, an etched area shown as a rectangle will typically have curved features. Accordingly, the regions shown in the figures are schematic in nature and their shapes are not intended to illustrate the actual shapes of regions of the device and are not intended to limit the scope of the exemplary embodiments.

Finally, it should be noted that the above embodiments are only used to illustrate the technical solution of the present disclosure, but not to limit it; although the present disclosure has been described in detail with reference to the foregoing embodiments, those of ordinary skill in the art should understand that it can still be Modifications may be made to the technical solutions described in the foregoing embodiments, or equivalent substitutions may be made to some of the technical features; however, these modifications or substitutions do not cause the essence of the corresponding technical solutions to deviate from the spirit and scope of the technical solutions of the embodiments of the present disclosure.

1. A display device, comprising:
a display panel; and
at least two grating panels, wherein each of the grating panels comprises a dielectric layer and a plurality of driving structures disposed on at least one side of the dielectric layer; and
each of the grating panels comprises a plurality of grating units, and each of the grating units comprises at least two of the driving structures; the driving structure is configured to receive a driving signal and form an electric field under action of the driving signal; the electric field is used for driving a corresponding position of the dielectric layer to transmit light or shield light, so as to enable the grating unit to form a light-transmitting unit and a light-shielding unit;
wherein the at least two grating panels comprise a first grating panel and a second grating panel, wherein the first grating panel and the second grating panel are stacked on a same side or two opposite sides of the display panel, and the grating units in the first grating panel and the grating units in the second grating panel are arranged along a first direction.

2. The display device according to claim 1, wherein each of the driving structures comprises a driving electrode, and a plurality of driving electrodes are arranged at intervals along the first direction;
wherein an arrangement period of the grating units in the first grating panel is different from an arrangement period of the grating units in the second grating panel, and a width of the driving electrode in the first grating panel along the first direction is different from a width of the driving electrode in the second grating panel along the first direction.

3. The display device according to claim 2, wherein the first grating panel and the second grating panel are both provided as one of:
the first grating panel and the second grating panel are both provided close to a display side of the display panel, and the second grating panel is located between the first grating panel and the display panel;
the first grating panel and the second grating panel are both provided facing away from the display side of the display panel, and the first grating panel is located between the second grating panel and the display panel;
the first grating panel is provided close to the display side of the display panel, and the second grating panel is provided facing away from the display side of the display panel;
wherein the arrangement period of the grating units in the first grating panel is less than the arrangement period of the grating units in the second grating panel, and the width of the driving electrode in the first grating panel along the first direction is less than the width of the driving electrode in the second grating panel along the first direction.

4. The display device according to claim 1, wherein the first grating panel is provided close to a display side of the display panel, and the second grating panel is provided facing away from the display side of the display panel; a distance between the first grating panel and the display panel is less than a distance between the second grating panel and the display panel.

5. The display device according to claim 1, wherein each of the driving structures comprises driving electrode, and a plurality of driving electrodes are arranged at intervals along the first direction;
wherein each of the grating panels further comprises a wiring layer located on a side of the driving electrode facing away from the dielectric layer, the wiring layer comprises a plurality of driving lines, at least part of the driving lines being connected to the driving electrode for transmitting the driving signal to the driving electrode;
each of the grating panels comprises a grating area, and the plurality of driving lines are arranged along a second direction within the grating area; an orthographic projection of the driving line on the display panel intersects with an orthographic projection of the plurality of driving electrodes on the display panel;
in the second direction, an orthographic projection of the driving line in the first grating panel on the display panel at least partially overlaps with an orthographic projection of the driving line in the second grating panel on the display panel.

6. The display device according to claim 5, wherein the display panel comprises:
a base substrate;
a plurality of display signal lines disposed on a side of the base substrate and arranged at intervals along the second direction; and
a plurality of first light-shielding strips disposed on a side of the plurality of display signal lines close to or facing away from the base substrate and arranged at intervals along the second direction, wherein
in the second direction, an orthographic projection of the plurality of driving lines on the base substrate at least partially overlaps with an orthographic projection of the plurality of display signal lines on the base substrate, and an orthographic projection of the plurality of first light-shielding strips on the base substrate covers the orthographic projection of the plurality of driving lines on the base substrate.

7. The display device according to claim 5, wherein the grating area comprises a common signal region; a driving line located in the common signal region has a plurality of first switching patterns, and the plurality of first switching patterns comprise first via switching patterns and first virtual switching patterns; the first via switching pattern is connected to the driving electrode, and the first virtual switching pattern is insulated from the driving electrode;
the plurality of first switching patterns are evenly arranged at equal intervals in the first direction within the common signal region.

8. The display device according to claim 7, wherein a size of an orthographic projection of the first via switching pattern on the display panel is greater than or equal to a size of an orthographic projection of the first virtual switching pattern on the display panel.

9. The display device according to claim 7, wherein the grating area further comprises a functional region; a driving line located in the functional region has a plurality of second switching patterns, and the plurality of second switching patterns comprise second virtual switching patterns; the second virtual switching pattern is insulated from the driving electrode;
wherein the plurality of second switching patterns are obtained by translating the plurality of first switching patterns along at least one of the first direction and the second direction.

10. The display device according to claim 9, wherein the plurality of second switching patterns are evenly arranged at equal intervals in the first direction within the functional region; and
an arrangement period of the plurality of first switching patterns in the first direction is different from an arrangement period of the plurality of second switching patterns in the first direction.

11. The display device according to claim 7, wherein the grating area comprises a plurality of common signal regions, and two of the common signal regions adjacent in the first direction are a first common signal region and a second common signal region; a plurality of first switching patterns in the first common signal region close to the second common signal region are located on substantially a same straight line as a plurality of first switching patterns in the second common signal region close to the first common signal region.

12. The display device according to claim 1, wherein, in the first direction, an orthographic projection of a grating area of the first grating panel on the display panel covers an effective display area of the display panel, and an orthographic projection of a grating area of the second grating panel on the display panel covers the effective display area;
in response to a distance between the first grating panel and the display panel being greater than a distance between the second grating panel and the display panel, a distance in the first direction between a boundary of the orthographic projection of the grating area of the first grating panel on the display panel and a boundary of the effective display area is greater than a distance in the first direction between a boundary of the orthographic projection of the grating area of the second grating panel on the display panel and the boundary of the effective display area;
in response to the distance between the second grating panel and the display panel being greater than the distance between the first grating panel and the display panel, the distance in the first direction between the boundary of the orthographic projection of the grating area of the second grating panel on the display panel and the boundary of the effective display area is greater than the distance in the first direction between the boundary of the orthographic projection of the grating area of the first grating panel on the display panel and the boundary of the effective display area.

13. The display device according to claim 1, wherein each of the driving structures comprises a driving electrode, and a plurality of driving electrodes are arranged at intervals along the first direction;
wherein in a state where the dielectric layers in the grating panels are all in a light-shielding state, a ratio of transmittance of the at least two grating panels to a thickness of the driving electrode is greater than or equal to 1.3*10⁻⁸ Å⁻¹, and less than or equal to 2.86*10⁻⁸ Å⁻¹.

14. The display device according to claim 1, wherein the display device is a three dimensional (3D) display device, and a crosstalk value between different viewpoint pictures of the 3D display device is less than or equal to 0.2%.

15. The display device according to claim 1, wherein the driving signal comprises a first voltage signal and a second voltage signal, wherein
each of the driving structures comprises a first electrode and a second electrode, the first electrode is configured to receive the first voltage signal, and the second electrode is configured to receive the second voltage signal; the first electrode and the second electrode are disposed on two opposite sides of the dielectric layer;
a plurality of first electrodes are communicated with each other as an integral structure, and a plurality of second electrodes are arranged along the first direction and are spaced apart from each other;
a plurality of second electrodes comprise a first sub-electrode and a second sub-electrode, wherein the first sub-electrode and the second sub-electrode are disposed on different film layers, and in the first direction, an orthographic projection of the first sub-electrode on the display panel and an orthographic projection of the second sub-electrode on the display panel are alternately arranged.

16. The display device according to claim 1, wherein the driving signal comprises a third voltage signal and a fourth voltage signal;
each of the driving structures comprises a third electrode and a fourth electrode; the third electrode is configured to receive the third voltage signal, and the fourth electrode is configured to receive the fourth voltage signal; the third electrode and the fourth electrode are disposed on a same side of the dielectric layer;
wherein the third electrode and the fourth electrode are disposed in one of the following manners:
the third electrode and the fourth electrode are disposed on different film layers, a plurality of third electrodes are communicated with each other as an integral structure, and a plurality of fourth electrodes are arranged along the first direction and are spaced apart from each other in a same film layer;
a plurality of third electrodes and a plurality of fourth electrodes are disposed on a same layer, wherein the plurality of third electrodes are arranged along the first direction and are spaced apart from each other, the plurality of fourth electrodes are arranged along the first direction and are spaced apart from each other, and the third electrodes and the fourth electrodes are provided alternately in the first direction.

17. The display device according to claim 1, wherein a ratio of an area of the light-transmitting unit to an area of the grating unit is greater than or equal to 0.4, and less than or equal to 0.6.

18. The display device according to claim 1, wherein the display device is a 3D display device, and the 3D display device further comprises:
an eyeball tracking module, configured to acquire a viewing distance; and
a driving module, connected to the eyeball tracking module and the driving structures and configured to adjust a position and a size of the light-transmitting unit in the grating unit according to the viewing distance.

19. A driving method of a display device, applied to the display device according to claim 1, wherein the display device comprises a display panel and at least two grating panels; each of the grating panels comprises a plurality of grating units, and a driving method of the grating unit comprises:
in a two dimensional (2D) display stage, providing a first driving signal to all driving structures located in a same grating unit to drive a corresponding position of the dielectric layer to transmit light so that the entire grating unit forms the light-transmitting unit; and
in a three dimensional (3D) display stage, providing the first driving signal to a part of the driving structures located in the same grating unit to drive a corresponding position of the dielectric layer to transmit light, and providing a second driving signal to another part of the driving structures located in the same grating unit to drive a corresponding position of the dielectric layer to shield light so that the grating unit form the light-transmitting unit and the light-shielding unit.

20. The driving method according to claim 19, wherein the driving structure comprises a common electrode and a driving electrode; the providing a first driving signal all to driving structures located in a same grating unit and the providing the first driving signal to a part of the driving structures located in the same grating unit comprise:
in a normally black mode, providing different voltage signals to the common electrode and the driving electrode to drive a corresponding position of the dielectric layer to transmit light; and
in a normally white mode, providing a same voltage signal to the common electrode and the driving electrode to drive the corresponding position of the dielectric layer to transmit light;
wherein the providing a second driving signal to another part of the driving structures located in the same grating unit comprises:
in the normally black mode, providing the same voltage signal to the common electrode and the driving electrode to drive the corresponding position of the dielectric layer to shield light; and
in the normally white mode, providing different voltage signals to the common electrode and the driving electrode to drive the corresponding position of the dielectric layer to shield light.
